(19) United States
(12) Patent Application Publication
(10) Pub. No.: US 2025/0021982 A1
(43) Pub. Date: Jan. 16, 2025

(54) DIGITAL ECOSYSTEM WITH DE-CENTRALIZED SECURE TRANSACTIONS AND EDGE AI TECHNOLOGY TO ENABLE PRIVACY PRESERVED ZERO-ID TRANSACTIONS

(71) Applicant: Trustgrid, LLC, Austin, TX (US)

(72) Inventors: Santosh Devaraj, Austin, TX (US); William Jason Turner, Pflugerville, TX (US); Aiden Herbert, San Jose, CA (US)

(21) Appl. No.: 18/582,365

(22) Filed: Feb. 20, 2024

Related U.S. Application Data
(60) Provisional application No. 63/447,027, filed on Feb. 20, 2023.
(60) Provisional application No. 63/455,899, filed on Mar. 30, 2023.
(60) Provisional application No. 63/455,905, filed on Mar. 30, 2023.
(60) Provisional application No. 63/555,220, filed on Feb. 19, 2024.

(51) Int. Cl. G06Q 20/40; G06Q 20/38

(52) U.S. Cl. CPC G06Q 20/4016; G06Q 20/382; G06Q 20/40145

(57) ABSTRACT

A system is provided which includes a plurality of users, each having a mobile Web3 node associated therewith, wherein each mobile Web3 node is equipped with a tangible, non-transient memory device having a set of software instructions recorded. The software instructions, when executed by at least one compute processor, perform the steps of establishing a hardware root of trust, establishing a biometric binding which is unique among the mobile Web3 nodes, and creating an AI with a user interface. The user interface receives input from a user and uses the input to generate privacy preserved zero-ID transactions, and to create a private chain network on the mobile Web3 node to establish and secure a P2P control channel for all communication with at least some of the plurality of users.

### CROSS-REFERENCE TO RELATED APPLICATIONS

The present application claims the benefit of priority from U.S. Provisional Application No. 63/447,027, filed on Feb. 20, 2023, which has the same title and the same inventors, and which is incorporated herein by reference in its entirety. The present application also claims the benefit of priority from U.S. Provisional Application No. 63/455,899 (Devaraj et al.), filed on Mar. 30, 2023, entitled “Fully Decentralized Blockchain Ecosystem”, which is incorporated herein by reference in its entirety. The present application also claims the benefit of priority from U.S. Provisional Application No. 63/455,905 (Devaraj et al.), filed on Mar. 30, 2023, entitled “Hardware Attested Decentralized Identifiers”, and which is incorporated herein by reference in its entirety. The present application also claims the benefit of priority from U.S. Provisional Application No. 63/555,220 (Devaraj), filed on Feb. 19, 2024, entitled “Systems For Generating And Leveraging Decentralized Identifiers”, and which is incorporated herein by reference in its entirety.

### FIELD OF THE DISCLOSURE

The present disclosure relates generally to digital ecosystems, and more particularly to digital ecosystems which facilitate decentralized secure transactions.

### BACKGROUND OF THE DISCLOSURE

Decentralized secure transactions involve the transfer of assets, such as cryptocurrency, in a decentralized network without the need for intermediaries such as banks. Transactions are typically secured using cryptography and are processed on a distributed ledger, such as blockchain, making them secure and resistant to tampering. The decentralized nature of these transactions allows for increased privacy and autonomy, as users can make transactions without the need for a central authority to approve or manage them.

Various examples of decentralized secure transactions are known to the art and are highlighted by cryptocurrency systems such as Bitcoin and Ethereum. In particular, Ethereum is a decentralized, open-source blockchain platform that enables the creation of decentralized applications (dapps) and the execution of smart contracts. It was created in 2015 by Vitalik Buterin and has since become one of the most popular blockchain platforms in the world. Ethereum's native cryptocurrency is Ether (ETH), which may be used to pay for transactions and computational services on the network. Unlike Bitcoin, which was primarily designed as a digital currency, Ethereum was designed to be a decentralized platform for building decentralized applications and executing smart contracts.

The Ethereum network allows developers to build and deploy decentralized applications that can run exactly as programmed without any downtime, censorship, or interference from a third party. This opens up a wide range of possibilities for decentralized applications, from finance and banking to supply chain management and voting systems.

A significant number of organizations have been developing new-generation services utilizing distributed ledger technology in permissioned enterprise environments. Most of these services are focused on specific use cases, such as supply chain management, financial use cases, or self-sovereign digital identity. While used in private enterprise environments, most of these systems are implemented based on design principles prevalent in public blockchain systems, inheriting limitations with confidentiality and privacy of transactions.

For example, there are existing blockchain-implemented identity systems, where identity attributes are stored off-chain (outside of the distributed ledger network), with identity identifiers recorded to a distributed ledger in the form of anonymous or pseudo-anonymous keys. These systems allow users to issue anonymous or pseudonymous assertions of their identity attributes, thus providing for a certain level of privacy of identity attributes and associated transactions. However, in cases where transactional policies need to be implemented in the form of blockchain-encoded smart contracts, such systems cannot provide strong privacy and confidentiality because, by design, all smart contract instructions are available to all nodes on the distributed network.

Some technologies have been developed to address the foregoing infirmity. For example, U.S. 2022/0188822 (Guzhevskiy et al.), which is incorporated herein by reference in its entirety, discloses a method of performing a transaction in relation to an identity centric dataset, wherein the method comprises: establishing, by a consortium network, a set of permitted data operations for a service network using a plurality of privacy schemas; receiving, by the service network, a transaction request to perform the transaction in relation to the identity centric dataset associated with a data owner; identifying, by the service network from the plurality of schemas and based on the transaction request, a privacy schema from the plurality of privacy schemas for use in performing the transaction; performing the transaction by executing, in a trusted execution environment of the service network, one or more data operations from the set of permitted data operations upon the identity centric dataset of the data owner as permitted by the identified privacy schema, thereby generating a manipulated dataset and transaction metadata; recording the transaction metadata to a distributed ledger of the service network; and transferring the manipulated dataset to a data receiver indicated by the transaction request.

### SUMMARY OF THE DISCLOSURE

In one aspect, a system is provided which comprises (a) a plurality of users, each having a mobile Web3 node associated therewith, wherein each mobile Web3 node is equipped with a tangible, non-transient memory device having a set of software instructions recorded therein which, when executed by at least one compute processor, perform the steps of (i) establishing a Hardware Root of Trust, (ii) establishing a biometric binding which is unique among the mobile Web3 nodes, and (iii) creating an AI with a user interface which receives input from a user and which uses the input to (1) generate privacy preserved zero-ID transactions, (2) create a private chain network on the mobile Web3 node and (3) use the private chain network to establish and secure a P2P control channel for all communication with at least some of the plurality of users.

In another aspect, a method is provided for creating a P2P network comprising a plurality of mobile Web3 nodes, wherein each Web3 node has one of a plurality of users associated with it, and wherein each Web3 node is equipped with a tangible, non-transient memory device. The method comprises establishing a Hardware Root of Trust; establishing a biometric binding which is unique among the mobile Web3 nodes; and creating an AI with a user interface which receives input from a user and which uses the input to enable privacy preserved zero-ID transactions and to create a private chain network on the mobile Web3 node to establish and secure a P2P control channel for all communication with at least some of the plurality of users.

### BRIEF DESCRIPTION OF THE DRAWINGS

FIG. 1 is an illustration of a technology stack which may be utilized in the systems and methodologies disclosed herein.

FIG. 2 is an illustration of an embodiment of a P2P network in accordance with the teachings herein.

### DETAILED DESCRIPTION

### I. Summary

It has now been found that the foregoing needs may be met with the systems and methodologies described herein. In a preferred embodiment, a mobile Web3 node is provided herein. This node is equipped with hardware root of trust and unique biometric binding and is controlled by a user on their device with edge AI technology to enable privacy preserved zero-ID transactions and document session enrollment. Various systems and methods for utilizing or leveraging the mobile Web3 node are also disclosed.

The provision of hardware root of trust in embodiments of the systems and methodologies disclosed herein enhances the security of node-to-node transactions in web3 networks. In particular, it provides a secure foundation for the nodes to operate on, as it establishes a secure connection between the hardware and software components of the device. Security of the node is further enhanced by combining hardware root of trust with biometric binding, since access to the device is then tied to a unique biometric identifier such as, for example, a fingerprint, a retinal map or facial recognition.

The use of biometric binding also affords greater privacy to users by making it more difficult for unauthorized individuals to access the device and its data, and enhances user experience by providing a convenient and fast way to access the device, eliminating the need for passwords and other forms of authentication. The use of biometric binding also enhances the accuracy of user authentication by reducing the risk of false negatives and false positives sometimes associated with other forms of authentication. Finally, the combination of hardware root of trust and biometric binding facilitates the tracking and verification of parties who access a device and the actions they have taken, thus making it easier to identify and prevent unauthorized access and data breaches, and to hold parties accountable for their actions on the device and in transactions associated with it.

One important aspect of preferred embodiments of the Web3 nodes disclosed herein relates to their ability to create private chain networks on mobile devices to secure and establish P2P control channels for all communications with the participating users. In contrast to public blockchain networks, access to private chain networks in preferred embodiments of the systems and methodologies described herein is restricted to trusted participants, thus affording greater security and control over the network and permitting customization of the network's rules and parameters.

Another important aspect of preferred embodiments of the Web3 nodes disclosed herein is their enablement of self-sovereign identity (SSI), coupled with an ability on the part of users to create digital verifiable credentials (VCs) on their mobile devices and enable consent-based sharing. The implementation of a decentralized digital identity model of this type, where individuals create and store their own digital identity on their device rather than relying on a centralized authority to store and manage their identity data, allows for greater privacy and control over personal information, and further allows users to choose which information to share and with whom. This approach significantly reduces the risk of identity theft and fraud, since user information is stored on the user's device. Storage of this information on a device with a small attack profile, in contrast to its storage on centralized servers that are vulnerable to hacking or data breaches, provides individuals with more control and autonomy over their digital identity, and allows them to participate in online activities with greater trust and security.

These attributes may be further enhanced in the systems and methodologies disclosed herein by coupling self-sovereign identity with digital verifiable credentials, since such credentials can be cryptographically signed and verified, can be easily shared with others to prove identity or meet certain requirements, can be used to store and manage personal information in a secure and decentralized manner, and can be used by individuals to prove their identity and qualifications in a trusted and secure way without the need for centralized authorities to verify their information. This may reduce the risk of identity fraud and improve the overall security and privacy of the identity verification process.

These attributes may also be enhanced in some of the systems and methodologies disclosed herein by coupling self-sovereign identity with consent-based sharing. This approach allows individuals or organizations whose information is being shared to retain control over their data and to decide who has access to the data and for what purposes it can be used. This approach to data sharing may be contrasted with more traditional models in which individuals or organizations have little or no control over how their information is used and shared, or in which data is collected and shared without the explicit consent of those affected.

Yet another important aspect of preferred embodiments of the Web3 nodes disclosed herein is the feature of anonymous trust. In particular, in some embodiments of the systems and methodologies disclosed herein, these Web3 nodes may be utilized to create a powerful digital ecosystem. This ecosystem may be utilized by consumers and by government, marketplace and commercial organizations to collaborate with authenticity, privacy, secrecy and non-repudiation.

Still another important aspect of preferred embodiments of the Web3 nodes disclosed herein is the use of these nodes in identity di-duplication and the elimination of false or inaccurate IDs. In particular, the unique biometric binding feature of the Web3 nodes disclosed herein may be utilized to ensure the accuracy and reliability of identities within a database or data system by providing a means to remove duplicate entries or to consolidate multiple entries relating to the same ID into a single entry, thereby reducing or eliminating inconsistencies or errors. Such de-duplication may be performed, for example, by using unique biometric binding features disclosed herein to compare records within a database and to identifying those that contain similar or identical information. This information may include, for example, personal details such as name, date of birth, address, and other identifying information. Once duplicates have been identified, they may be consolidated into a single, accurate record.

Those skilled in the art will appreciate that identity de-duplication is particularly important in scenarios where accurate and up-to-date information is critical as, for example, in transactions involving financial services, healthcare, and government institutions. For example, in healthcare, the de-duplicating process described above may be applied to patient records to ensure that patient information is accurate and complete, which may improve patient outcomes and reduce medical errors. Those skilled in the art will further appreciate that the unique biometric binding feature of preferred embodiments of the Web3 nodes disclosed herein provides a means by which false or inaccurate IDs may be readily identified and removed from a system or database.

### II. Main Features

### A. Technology Stack

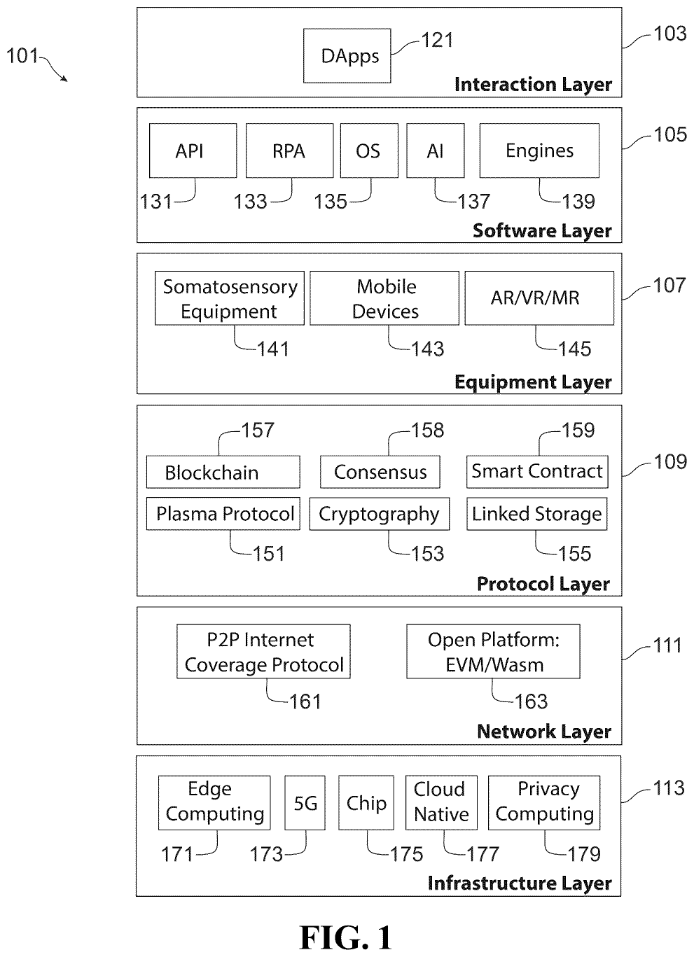

Embodiments of some of the systems and methodologies disclosed herein may be further understood in reference to the particular, non-limiting embodiment of a technology stack 101 of FIG. 1 which may be utilized in the implementation of these systems and methodologies. In the context of Web3, a technology stack refers to the collection of technologies, protocols, frameworks, and tools used to build and run decentralized applications (DApps) and services. This stack will preferably include blockchain technology for secure and transparent transactions, smart contracts for automated agreements, decentralized storage solutions for data integrity, peer-to-peer networking for distributed systems, and cryptographic methods for security. The technology stack 101 aims to create a more open, trustless, and permissionless web, enabling direct user interaction without intermediaries, enhanced privacy, and new forms of online interactions and content consumption. The technology stack 101 preferably supports a wide range of Web3 applications, from decentralized finance (DeFi) and digital identity (DID) to innovative social media platforms and multimedia content creation, providing a cross-era user experience through advanced technology integration.

The Web3 technology stack 101 depicted in FIG. 1 may be conceptualized into six layers: an interaction layer 103, a software layer 105, an equipment layer 107, a protocol layer 109, a network layer 111, and an infrastructure layer 113. Each of these layers is described in greater detail below.

The infrastructure layer 113 encompasses a variety of foundational technologies designed to support a more decentralized, efficient, and secure internet. This layer in this embodiment includes advancements such as 5G technology 173 to provide faster and more reliable network connectivity, thus enhancing the efficiency of Web3 applications. The infrastructure layer 113 in this embodiment also includes advanced chips 175 for improved computing power, enabling more sophisticated processing capabilities for complex Web3 applications.

The infrastructure layer 113 further includes a distributed architecture and edge computing 171 to facilitate decentralized data processing closer to the source of data generation, thereby improving speed and reducing latency. The infrastructure layer 113 also includes cloud-native technologies 177 for scalable and flexible application development and deployment, supporting the dynamic nature of Web3 services. Finally, the infrastructure layer 113 includes privacy computing 179 to ensure the protection and confidentiality of data as it is processed, addressing the growing concerns over data privacy in the digital age. These components work together to provide a robust foundation for the development and operation of Web3 applications, ensuring they are fast, reliable, and secure.

The network layer 111 serves as a foundation for decentralized connectivity, facilitating direct peer-to-peer (P2P) interactions and supporting the operation of decentralized applications (DApps) on open platforms. Specifically, the P2P Internet Coverage Protocol 161 aims to enable devices to connect and communicate directly over the internet without central servers, enhancing privacy, security, and efficiency. The Open Platform: EVM/WASM 163 feature refers to platforms that support Ethereum Virtual Machine (EVM) and WebAssembly (WASM), enabling the development and execution of smart contracts and decentralized applications in a more efficient, secure, and interoperable environment. These components may be crucial for creating a decentralized web, where users have greater control over their data and interactions.

The protocol layer 109 encompasses technologies and standards that enable secure, interoperable, and decentralized operations across the web. In the particular embodiment of the technology stack 101 depicted, this layer includes a distributed ledger technology (blockchain) 157 for maintaining a secure and decentralized record of transactions, and plasma protocol 151, an off-chain scaling solution designed to increase the throughput of blockchains by handling transactions off the main chain while ensuring security and data integrity. These components are foundational for creating a trustless, transparent, and efficient digital ecosystem, supporting functionalities such as smart contracts 159, consensus mechanisms 158, cryptography 153 and secure data storage 155, thereby facilitating the development of decentralized applications (DApps).

The cryptography feature 153 in the protocol layer 109 of the Web3 technology stack 101 is crucial for ensuring the security and privacy of transactions and data. It employs mathematical algorithms to encrypt and decrypt information, enabling secure communication in an otherwise transparent network. Cryptography underpins various aspects of Web3, including the creation of digital signatures for verifying transaction authenticity, generating public and private keys for wallet security, and ensuring the integrity of data on the blockchain. This feature is foundational to maintaining trust and security in decentralized networks, safeguarding against fraud, and protecting user privacy.

The equipment layer 107 in the Web3 technology stack 101 consists of various hardware technologies that enable immersive, interactive, and accessible experiences. Together, these components play a vital role in shaping the user experience in the Web3 era. They not only enable more immersive and interactive digital experiences but also ensure that Web3 applications and services are accessible across a wide range of devices, broadening participation and fostering innovation in the digital space.

In the particular, non-limiting embodiment of the technology stack 101 depicted, the equipment layer 107 includes AR/VR/MR (Augmented Reality/Virtual Reality/Mixed Reality) technologies 145. These technologies may be leveraged to create immersive experiences by blending digital content with the physical world (AR), creating entirely digital environments (VR), or merging both for enhanced interactive experiences (MR). In Web3, AR/VR/MR may be utilized to revolutionize user interfaces by providing more engaging and intuitive ways to interact with digital assets, environments, and applications. These technologies have applications in various fields including, for example, education, entertainment, and real estate, and offer users novel ways to explore information, socialize, and participate in digital ecosystems.

In the particular embodiment of the technology stack 101 depicted, the equipment layer 107 also includes somatosensory equipment 141. Such equipment may include devices that detect and respond to physical movements or gestures, enabling users to interact with digital applications through body motion. This equipment may also include motion sensors, haptic feedback devices, and wearable technology, contributing to more natural and intuitive user interactions with digital content. In the Web3 context, somatosensory equipment 141 may enhance the user experience in gaming, virtual meetings, and physical rehabilitation programs, among others, allowing for a deeper level of immersion and interaction with the digital world.

The equipment layer 107 in the embodiment of the technology stack 101 depicted also includes mobile devices 143. Typically, smartphones and tablets are essential components of the equipment layer 107, providing widespread access to Web3 applications. They serve as the primary interface for many users, offering portability, convenience, and connectivity. Mobile devices 143 facilitate access to decentralized applications (DApps), cryptocurrency wallets, and blockchain-based services, facilitating on-the-go participation in the digital economy, social media, and various other Web3 applications.

The software layer 105 in the Web3 technology stack 101 depicted encompasses several important components for the development, operation, and interaction of decentralized applications and services. Together, these components of the software layer 105 contribute to the functionality, efficiency, and user experience of Web3 applications, supporting the development of decentralized, automated, and intelligent solutions across various industries and use cases.

The software layer 105 leverages Artificial Intelligence (AI) 137, which may play a critical role in the software layer by enabling intelligent decision-making, automation, and enhanced user experiences. AI may be used for a variety of purposes, including data analysis, predictive modeling, natural language processing, and automation of complex tasks. In the context of Web3, AI may help in optimizing network operations, enhancing security through anomaly detection, and providing personalized user experiences.

The engines 139 component of the technology stack 101 refers to the development engines and frameworks that provide the necessary tools and libraries for building Web3 applications. These engines 139 may include software development kits (SDKs) for blockchain platforms, game engines for creating decentralized games, or any other specialized software that facilitates the development of DApps. They play an important role in simplifying the development process, thus allowing developers to focus on innovation rather than the intricacies of the underlying technology.

In the Web3 stack 101, the operating system component 135 does not refer to traditional operating systems like Windows or macOS, but refers instead to platforms and environments that support the running of decentralized applications. These may include blockchain-specific operating systems designed to manage the execution of smart contracts, handle transactions, and ensure interoperability between different blockchain networks. They provide the foundational layer on which DApps operate, ensuring stability, efficiency, and security.

APIs (Application Programming Interfaces) 131 in the Web3 software layer enable communication between different software components, services, and applications. They allow DApps to access external services or data, interact with smart contracts, or integrate with other applications and blockchain networks. APIs 131 are pivotal for building interconnected and interoperable applications, facilitating a seamless exchange of information and value across the decentralized web.

RPA (Robotic Process Automation) 133 involves the use of software robots or “bots” to automate repetitive and rule-based tasks that previously required human intervention. In the context of Web3, RPAs 133 may be leveraged to streamline operations, reduce errors, and increase efficiency by automating processes such as, for example, transaction processing, smart contract execution, or data verification. RPAs 133 enable organizations to optimize their workflows, freeing up resources for more strategic tasks.

The interaction layer 103 is where decentralized applications (DApps) 121 operate. DApps utilize the underlying blockchain for decentralized processing, leveraging smart contracts for automation and executing transactions without the need for central intermediaries. The interaction layer 103 may be crucial for user interaction with the decentralized web, providing interfaces and experiences powered by the underlying technologies such as blockchain, smart contracts, and decentralized storage systems.

DApps play a pivotal role in this layer by serving as the point of interaction for users with the decentralized network. They offer various services and functionalities ranging from financial services (DeFi), games, social networks, to marketplaces, all operating on a decentralized infrastructure that promotes transparency, security, and user sovereignty. Through DApps, users may engage in transactions, participate in governance, and contribute to the decentralized ecosystem, embodying the principles of Web3 in practical, user-facing applications.

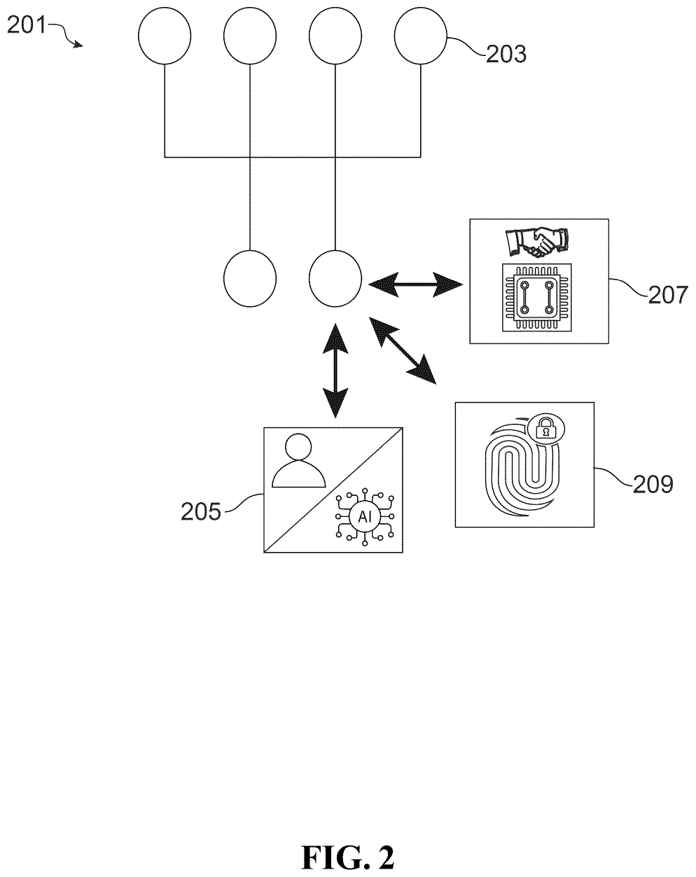

FIG. 2 depicts a particular, nonlimiting embodiment of a P2P network 201 in accordance with the teachings herein. The network 201 comprises a plurality of mobile Web3 nodes 203, each of which has one of a plurality of users associated with it. Each Web3 node 203 is equipped with a tangible, non-transient memory device having a set of software instructions recorded therein which, when executed by at least one computer processor, performs methods of the type disclosed herein.

Each Web3 node 203 is equipped with a Hardware Root of Trust (HRoT) 207. The HRoT 207 is a foundational security mechanism embedded within each mobile Web3 node 203 which is primarily based on secure cryptographic processors integrated into the device. The HRoT is responsible for generating and securely storing cryptographic keys, enabling tamper-resistant encryption and decryption processes. The HRoT 207 facilitates the establishment of a secure and trusted environment from the moment the device boots up, and forming the basis for all subsequent security measures, including biometric binding and secure communications within the peer-to-peer network.

Each Web3 node 203 is further equipped with biometric binding 209. This refers to the process of securely associating a user's unique biometric identifiers, such as fingerprints, facial recognition, or iris scans, with their mobile Web3 node 203. This ensures that each Web3 node 203 is uniquely tied to its user, enhancing security by using biometric data to authenticate the user before they can access the node, perform transactions, or communicate over the peer-to-peer network. This method of authentication plays a crucial role in preserving privacy and reinforcing the security framework of the decentralized system.

Each Web3 node 203 is further equipped with an AI user interface 211. The AI user interface 211 acts as a sophisticated intermediary between the user and the mobile Web3 node 203. It processes inputs from the user to facilitate secure, privacy-preserved transactions known as zero-ID transactions and to establish a private chain network for secure peer-to-peer communication. This interface is designed to be intuitive, leveraging artificial intelligence to adapt to user behaviors and preferences, thereby enhancing the user experience while maintaining high security and privacy standards.

### B. Web3 Edge Node With Root-of-Trust

As the next generation of the Internet, Web3 aims to build a decentralized and more open web. Unlike the current web (web2), which is primarily centralized and controlled by a few large corporations, Web3 is intended to empower individuals and communities by enabling them to have more control over their data, applications, and online identity.

One of the key technologies driving Web3 is blockchain, which provides a decentralized ledger that can be used to store and exchange data, assets, and value. As noted above, the Web3 stack also preferably includes decentralized technologies such as peer-to-peer networks, cryptography, and smart contracts.

The Web3 ecosystem is centered around the idea of empowering users and giving them more control over their online experiences. This includes providing new opportunities for financial transactions, creating new forms of digital identity, and enabling new models for data ownership and control.

Providing Web3 nodes with a root of trust confers additional benefits on them in terms of increased security, improved reliability, enhanced privacy, and regulatory compliance.

For example, the root of trust, which may be implemented as a hardware security module (HSM), acts as a secure anchor that can be used to secure the Web3 node and protect it from malicious attacks. The HSM can store cryptographic keys, certificates, and other sensitive information that can be used to secure the node and its communications. Moreover, by having a secure root of trust, the reliability of the Web3 node may be improved, since the HSM can help ensure the authenticity and integrity of data and communications. This can improve the overall stability and security of the Web3 network.

The root of trust can be used to encrypt sensitive data and communications, which can enhance privacy and protect the confidentiality of user data. This is especially important in web3 networks and applications where privacy and security are critical concerns.

In some embodiments of the systems and methodologies disclosed herein, the use of a root of trust may be a requirement for compliance with regulations and industry standards. For example, in the financial industry, stringent regulations exist pertaining to the protection of customer data and the use of cryptographic keys.

### 1. Creation of Web3 Nodes

Web3 nodes are an integral part of some of the systems and methodologies disclosed herein. Web3 nodes may be created with suitable software on a blockchain platform that implements the Web3 stack, such as Ethereum, POA Network, or EOS. Depending on the platform, a full node client, such as Geth, Parity, or Besu, as well as the Web3.js library may be required for node creation.

After creation, the node must be synchronized with the rest of the network, a process which may involve downloading the entire blockchain data onto a local machine. After the synchronization process is complete, the Web3 node may be started, thus making it available to the network and allowing it to participate in consensus generation and in the validation of transactions. After the node is running, a user can connect to it using the Web3.js library as, for example, by creating a Web3 instance and specifying the endpoint to the node. This instance may then be utilized by a user to interact with the blockchain and execute smart contracts, transfer tokens, and take other such actions.

### 2. Imparting Root of Trust to Web3 Nodes

A root of trust is a foundation or anchor of trust in a system that provides a secure base from which other security measures can be built. In a Web3 node, a root of trust is established by verifying the authenticity and integrity of the software and data used by the node. This helps to ensure that the node is not compromised by malicious actors and that it can be trusted to participate in the blockchain network in a secure and reliable manner.

In embodiments of the systems and methodologies described herein, a root of trust may be imparted to a Web3 node in various ways. These include, but are not limited to, through the use methods involving digital signatures, cryptographic hash functions, trusted execution environments, and reputation systems. Each of these items is discussed in greater detail below.

Digital signatures may be used to impart a root of trust to a Web3 node by using the signature, after software is digitally signed, to verify the authenticity and integrity of the code. This helps to ensure that the software has not been tampered with and that it is safe to use.

Cryptographic hash functions may be used to impart a root of trust to a Web3 node by creating a unique fingerprint of the software and data used by the node. The hash may be used to verify the authenticity and integrity of the data, and to detect any changes that may have been made.

Trusted execution environments (TEEs) are specialized hardware components that provide a secure environment for running code. TEEs may be utilized to impart a root of trust to a Web3 node by providing a secure environment for the node software to run in.

Reputation systems may be used to establish trust between nodes in a blockchain network. A Web3 node can establish a reputation for itself by participating in the network in a secure and trustworthy manner, and by demonstrating its reliability over time.

By establishing a root of trust, a Web3 node can provide a secure foundation for its interactions with the blockchain network and with other nodes. This helps to ensure the security and integrity of the network, and to support the decentralization and transparency that are core principles of Web3.

### 3. Imparting Unique Bio Metric Binding to Web3 Nodes

Unique biometric binding refers to the process of linking an individual's biometric data (such as, for example, fingerprints, facial features, or iris patterns) to a digital identity in a secure and privacy-sensitive manner. In some embodiments of the systems and methodologies disclosed herein, unique biometric binding may be used to create a secure and trusted digital identity that may be used for a variety of purposes such as, for example, accessing secure resources, executing transactions, or participating in decentralized applications.

In some embodiments of the systems and methodologies disclosed herein, unique biometric binding may be imparted to a Web3 node in a variety of ways. These include, but are not limited to, imparting such a binding through biometric authentication, biometric encryption, biometric signatures, or through the use of decentralized identity systems. Each of these items is discussed in greater detail below.

Biometric authentication is a process of using biometric data, such as fingerprints or facial recognition, to verify an individual's identity. This may be used to securely bind an individual's biometric data to their digital identity in a Web3 node.

Biometric encryption is a process of using biometric data as a key to encrypt data. This may be used to securely bind an individual's biometric data to their digital identity in a Web3 node and to ensure that only they have access to the data.

Biometric signatures are a type of digital signature that use biometric data as a key. These may be used to bind an individual's biometric data to their digital identity in a Web3 node and to provide a secure means of signing transactions and executing smart contracts.

Decentralized identity systems, such as self-sovereign identity (SSI) systems, use blockchain technology to provide secure, privacy-sensitive digital identities. These systems may be used to bind an individual's biometric data to their digital identity in a Web3 node, and to ensure that their identity is secure, portable, and controlled by the individual.

By imparting unique biometric binding to a Web3 node, individuals may establish a secure and trusted digital identity that may be used to access secure resources, execute transactions, and participate in decentralized applications. This helps to support the goal of empowering individuals and communities in the Web3 ecosystem.

In preferred embodiments of the systems and methodologies disclosed herein, a mobile Web3 node is provided which is equipped with hardware root of trust and unique biometric binding. The node is controlled by a user on their device with edge AI technology to enable privacy preserved zero-ID transactions and document session enrollment. Various systems and methodologies for utilizing or leveraging the mobile Web3 node are also disclosed herein.

The provision of hardware root of trust in some embodiments of the systems and methodologies disclosed herein enhances the security of node-to-node transactions. In particular, it provides a secure foundation for the nodes to operate on, as it establishes a secure connection between the hardware and software components of a device. Security of the node is further enhanced by combining hardware root of trust with biometric binding, since access to the device is then tied to a unique biometric identifier such as, for example, a fingerprint, a retinal map or facial recognition. The use of biometric binding also affords greater privacy to the users by making it more difficult for unauthorized individuals to access the device and its data. Biometric binding may also enhance user experience by providing a convenient and fast way to access the device, thus eliminating the need for passwords and other forms of authentication. The use of biometric binding also enhances the accuracy of user authentication by reducing the risk of false negatives and false positives sometimes associated with other forms of authentication. Finally, the combination of hardware root of trust and biometric binding facilitates the tracking and verification of parties who access a device and the actions they have taken, thus making it easier to identify and prevent unauthorized access and data breaches and to hold users accountable for their actions on a network.

### 4. Using Edge AI Technology to Enable Privacy Preserved Zero ID Transactions

In some embodiments of the systems and methodologies described herein, edge AI technology can be used to enable privacy-preserved zero ID transactions by running AI algorithms locally on a user's device, such as a mobile device or a sensor, rather than in a central cloud or data center. This may help to preserve privacy by keeping sensitive data, such as biometric data or transaction data, on the device and reducing the amount of data that is transmitted over the network. The process of using edge AI technology to enable privacy-preserved zero ID transactions may involve the steps of collecting biometric data, running AI algorithms on the user's device to create a digital signature, securing the digital signature, and using the secured digital signature for transactions. Each of these steps is described in greater detail below.

The collection of biometric data typically involves the collection of fingerprints, retinal scans, the use of facial recognition, or other suitable means for collecting biometric data from the user. This data can then be used as a unique identifier for the user and can also be used to secure transactions.

The creation of a digital signature typically involves utilizing edge AI technology to run AI algorithms on the user's device. These algorithms process the biometric data and extract suitable features from it which may be utilized to generate a digital signature that may be used to secure transactions. The digital signature is then preferably secured using cryptographic techniques such as, for example, encryption or the application of digital signatures. This may help to ensure that the digital signature is unique to the user and cannot be tampered with.

The digital signature may then be utilized to execute transactions, such as sending or receiving payments or accessing secure resources, without requiring the user to provide additional personal information. This may help to preserve privacy by reducing the amount of personal data that is shared and by making it more difficult for malicious actors to link transactions to the user.

By using edge AI technology to enable privacy-preserved zero ID transactions, individuals may maintain control over their personal data and protect their privacy while still being able to participate in the Web3 ecosystem. This may help to promote trust and security in the ecosystem and support the goal of empowering individuals and communities in the Web3 ecosystem.

### 5. Document Session Enrollment

As previously noted, zero ID transactions are a type of authentication process that enables users to complete transactions without the need to provide personal identification information, relying instead on the use of various types of biometric data and device-based authentication to confirm the user's identity. Document session enrollment is an integral part of the zero ID authentication process. During this step, the user's biometric information (such as, for example, a fingerprint or retinal scan) is captured and linked to the device being used for the transaction. This information is then encrypted and securely stored on the device.

Once the biometric data has been captured and enrolled, it may then be used to authenticate the user for subsequent transactions. When the user initiates a transaction, the device's biometric scanner is used to confirm their identity. The encrypted biometric information is then compared to the enrolled data to determine if there is a match. If a match is found, the transaction is approved, and the user is granted access.

### B. Private Chain

One important aspect of preferred embodiments of the Web3 nodes disclosed herein relates to their ability to create private chain networks on mobile devices to secure and establish P2P control channels for all communication with participating users. In contrast to public blockchain networks, access to private chain networks is restricted to trusted participants, thus affording greater security and control over the network and permitting customization of the network's rules and parameters.

In some embodiments of the systems and methodologies described herein, various techniques may be utilized to create private chain networks and to use these networks to establish and secure P2P control channels for communication in accordance with the teachings herein. One particular, nonlimiting embodiment of such a process includes the steps of choosing a blockchain platform, setting up the network, adding nodes to the network, deploying smart contracts on the network, establishing a P2P control channel, implementing security measures, and testing the network. These steps of this embodiment are described in greater detail below.

The first step involves selection of a blockchain platform that supports the creation of private chains on mobile devices. Some blockchain platforms may be utilized for this purpose include Ethereum and Hyperledger.

Once the platform has been selected, the network is set up on the mobile devices. This involves configuring the nodes, setting up suitable consensus mechanisms, and defining the network rules. Ethereum is a decentralized, open-source blockchain system that features smart contract functionality. It enables developers to build and deploy decentralized applications (DApps) and is powered by its native cryptocurrency, Ether (ETH). Hyperledger, on the other hand, is an umbrella project of open-source blockchains and related tools, started by the Linux Foundation, aimed at advancing blockchain technology for cross-industry applications. It focuses on improving the reliability and performance of blockchain networks for business use cases, supporting various distributed ledger frameworks including Hyperledger Fabric, which is designed for developing enterprise-grade blockchain applications.

Nodes are then added to the network. Nodes are the participants in a blockchain network and may be added by inviting other users to join the network using their mobile devices.

Once the network has been set up and nodes have been added to it, smart contracts are deployed on the network. Smart contracts define the rules for transactions on the network.

In order to establish a P2P control channel for communication between the participating users, a decentralized communication protocol such as the InterPlanetary File System (IPFS) may be utilized. IPFS enables P2P communication between nodes by allowing them to share files and data in a decentralized manner. Other decentralized communication protocols that may be utilized for this purpose include, but are not limited to, Whisper, Matrix and libp2p. Whisper, part of the Ethereum project, is a communication protocol for DApps to communicate with each other on the Ethereum blockchain. It iss designed for small-scale, private communications. Matrix is an open standard for real-time communication over the Internet. It supports secure, decentralized chat rooms and voice/video calls. Matrix is designed to make real-time communication work seamlessly between different service providers. libp2p is a modular network stack that enables the development of decentralized peer-to-peer applications. It provides the foundation for building complex applications where nodes can communicate directly without relying on centralized servers.

To ensure the security of the network, it is important to implement security measures such as encryption and authentication. This may be achieved by using secure protocols such as Transport Layer Security (TLS) and Secure Sockets Layer (SSL) to encrypt the communication between the nodes.

Before the network is put into production, it is important to test it to ensure that it is functioning as expected. This may involve conducting performance tests, security tests, and functional tests.

Adherence to the foregoing steps allows a private chain network to be created on mobile devices to secure and establish a P2P control channel for communication between participating users. This type of network may be useful for applications that require a secure and decentralized communication channel, such as P2P payment systems, secure messaging, and decentralized file storage.

### C. SSI & VCs

Another important aspect of some embodiments of the Web3 nodes disclosed herein is their enablement of self-sovereign identity (SSI), coupled with an ability on the part of users to create digital verifiable credentials (VCs) on their mobile devices and to enable consent-based sharing. The implementation of a decentralized digital identity model of this type—where individuals create and store their own digital identity on their device rather than relying on a centralized authority to store and manage their identity data—allows for greater privacy and control over personal information, and further allows users to choose which information to share and with whom. This approach significantly reduces the risk of identity theft and fraud since user information is stored on the user's device. Storage of this information on a device with a small attack profile, in contrast to its storage on centralized servers that are vulnerable to hacking or data breaches, provides individuals with more control and autonomy over their digital identity, and allows them to participate in online activities with greater trust and security.

In some embodiments of the systems and methodologies disclosed herein, these attributes may be further enhanced by coupling self-sovereign identity with digital verifiable credentials, since such credentials may be cryptographically signed and verified, may be easily shared with others to prove identity or meet certain requirements, may be used to store and manage personal information in a secure and decentralized manner, and may be used by individuals to prove their identity and qualifications in a trusted and secure way without the need for centralized authorities to verify their information. This may reduce the risk of identity fraud and improve the overall security and privacy of the identity verification process.

### 1. Self-Sovereign Identity (SSI)

As noted above, self-Sovereign Identity (SSI) is a decentralized approach to identity management that gives individuals control over their personal data and digital identity. In some embodiments of the Web3 networks described herein, SSI may be implemented using blockchain technology and decentralized key management systems.

In preferred embodiments of the SSI systems disclosed herein, each user has a unique digital identity that is represented by a decentralized identifier (DID), which acts as a pointer to the user's identity information stored on the blockchain. The user's identity information is encrypted and stored in a decentralized database, such as a blockchain, which allows for secure and tamper-proof storage of the data.

The user controls their digital identity through their private keys, which are stored in a secure manner, such as on a hardware wallet or in a secure enclave on their device. When a user wants to prove their identity to another party in the network, they may do so by presenting a signed claim that includes their DID and a hash of their identity information. The other party may then verify the authenticity of the claim by checking the signature against the user's public key and comparing the hash of the identity information with the information stored on the blockchain.

In the foregoing SSI systems, the user has control over their personal data and may choose to share only the information that is necessary for a particular transaction. This reduces the risk of identity theft and misuse of personal information and provides greater privacy and security for the user. By using such an SSI in a Web3 network, individuals have control over their digital identity and the information associated with it, enabling them to take control of their personal data and giving them the power to choose how and when it is used. This may lead to greater trust and transparency in online transactions and may help to create a more secure and equitable online world.

### 2. Digital Verifiable Credentials (VCs)

Digital Verifiable Credentials (VCs) are digital representations of trust-based relationships that allow individuals and organizations to securely exchange information and proof of qualifications, memberships, and other attributes. In some embodiments of the Web3 networks disclosed herein, VCs may be implemented using blockchain technology and decentralized key management systems.

A VC is comprised of a set of claims about an individual or an organization, such as their name, address, qualifications, or memberships. These claims are digitally signed by a trusted issuer, such as a government agency, educational institution, or professional organization, and may be verified by other parties in the network.

In some embodiments of the Web3 networks disclosed herein, VCs may be represented as digital tokens that are stored on a blockchain such as, for example, the Ethereum, Tezos, Cardano, Hyperledger Fabric, or Algorand blockchains. The VCs are associated with the individual or organization's digital identity, represented by a decentralized identifier (DID), which acts as a pointer to the VCs stored on the blockchain.

When an individual wants to prove their attributes to another party in the network, they may do so by presenting their VCs, which are verified using the issuer's public key. The VCs may also be presented along with the individual's DID, which acts as proof of their digital identity.

By using digital VCs in these Web3 networks, individuals and organizations may securely exchange information and proof of qualifications and memberships, without the need for intermediaries. This may lead to greater trust and efficiency in online transactions and may reduce the risk of fraud and misinformation. Additionally, VCs may be used to create a more equitable and inclusive digital world by allowing individuals to prove their qualifications and attributes to a wider range of potential employers, partners, and customers.

### 3. Consent-Based Sharing

In some embodiments of the systems and methodologies disclosed herein, the foregoing attributes may also be enhanced by coupling self-sovereign identity with consent-based sharing. This approach allows individuals or organizations whose information is being shared to retain control over their data and to decide who has access to it and for what purposes it may be used. This approach to data sharing may be contrasted with more traditional models in which individuals or organizations have little or no control over how their information is used and shared, or in which data is collected and shared without the explicit consent of those affected.

Consent-based sharing between Web3 nodes may be implemented in some embodiments of the systems and methodologies disclosed herein by using smart contracts and decentralized identity management systems. Various techniques may be utilized to implement consent-based sharing in the systems and methodologies disclosed herein. In one particular, nonlimiting embodiment of such a technique, consent-based sharing is implemented by leveraging decentralized identity management and smart contracts to make a request for data sharing, to grant or deny the request, and to generate an audit trail. These items are described in further detail below.

In order to implement consent-based sharing, it is typically necessary to first establish a decentralized identity management system. This system assigns a unique digital identity to each node in the network and allows nodes to control access to their personal data.

Decentralized identity management involves the management of digital identities without reliance on centralized authorities or intermediaries. Typically, embodiments of these systems utilize blockchain technology to create a secure and decentralized system for managing and verifying identities. In a decentralized identity management system, each user has a unique digital identity that is stored on a blockchain. This digital identity may be used to securely store and manage personal information, such as name, address, and date of birth. The user has full control over their digital identity and may choose to share specific information with others or keep it private.

Storage of the user's identity information in a decentralized database, such as a blockchain, allows for secure and tamper-proof storage of identity data. The user's identity information is linked to a unique digital identity, which is represented by a decentralized identifier (DID). The DID acts as a pointer to the user's identity information stored on the blockchain and provides a secure way for the user to prove their identity to others in the network.

In some embodiments of the systems and methodologies disclosed herein, decentralized key management systems may be utilized to ensure that the user has control over their digital identity and the information associated with it. The user's private keys, which may be used to sign transactions and access their digital identity, are stored in a secure manner, such as on a hardware wallet or in a secure enclave on their device. When a user wants to prove their identity to another party in the network, they may do so by presenting a signed claim that includes their DID and a hash of their identity information. The other party may then verify the authenticity of the claim by checking the signature against the user's public key and comparing the hash of the identity information with the information stored on the blockchain.

The use, in some embodiments of the systems and methodologies disclosed herein, of a decentralized identity management system offers several benefits compared to the use of traditional centralized identity management systems. These include increased security (since there is no central point of failure that can be targeted by hackers), improved privacy (since users have full control over their personal information), and greater efficiency (since the use of a decentralized system eliminates the need for intermediaries and reduces the time and cost associated with identity verification).

Smart contracts may be used to manage the consent process between nodes. The smart contract is a self-executing contract with the terms of the agreement between buyer and seller being directly written into lines of code. It defines the rules for data sharing and ensures that data can only be shared with the consent of the node that owns it. Hence, the smart contract facilitates the transaction by automating the consent process and by ensuring that all parties have properly agreed to the terms and conditions of the transaction. In a decentralized identity management system of the type described herein, smart contracts may be used to manage the process of granting and revoking consent for the sharing of personal data.

When a user wants to share their identity information with another node, they may initiate a transaction on the blockchain that invokes a smart contract. The smart contract may specify the terms and conditions of the data sharing, such as the type of data that can be shared, the time period for which the consent is valid, and the actions that can be taken with the data. In this way, smart contracts may automate the consent process and ensure that all parties properly agree to the terms and conditions of the data sharing before it takes place. This helps to provide greater transparency and security in the data sharing process and ensures that the user's personal data is protected and only used in accordance with their consent.

When the other node receives the request, they may either accept or reject the terms and conditions specified in the smart contract. If they accept the terms, the smart contract is executed, and the data sharing process begins. The smart contract may also be programmed to automatically revoke the consent if certain conditions are not met (such as, for example, if the data sharing agreement is breached or if the user revokes their consent).

When a node wants to access data from another node, it sends a request to the node that owns the data. The request includes information about the data that is being requested and the reason for the request. The node that owns the data then decides whether to grant or deny consent for the data to be shared. If the node grants consent, the data is shared with the requesting node. If the node denies consent, the data is not shared and the request is rejected.

To ensure transparency and accountability, in some embodiments of the systems and methodologies described herein, an audit trail is maintained of all data sharing requests and the decisions made by nodes. This audit trail may be used to verify that data was only shared with the consent of the node that owns it.

In some embodiments of the systems and methodologies described herein, an audit trail in a smart contract transaction may be implemented by storing a record of all transactions and changes made to the smart contract on the blockchain. In such embodiments, each transaction that is executed on the blockchain may be recorded in a block, which is linked to the previous block, thereby forming a chain of blocks. This chain of blocks, known as the blockchain, provides a tamper-proof and immutable record of all transactions that have taken place on the network.

In a smart contract transaction, each interaction with the smart contract, such as a change in the state of a variable or the execution of a function, is recorded on the blockchain as a transaction. This provides a permanent and transparent record of all actions taken within the smart contract, allowing anyone to track the flow of events and to verify the outcome of the transaction.

Additionally, in some embodiments of the systems and methodologies described herein, smart contracts may be programmed to include logging functions that store specific events or changes to the state of the contract in a dedicated log on the blockchain. This log may be used to track the execution of the smart contract and to provide an audit trail of all changes made to the contract.

Through use of the foregoing approach, an audit trail in a smart contract transaction can be implemented by utilizing the transparent and tamper-proof nature of the blockchain to record all transactions and changes made to the smart contract. This helps to increase the transparency and accountability of the transaction and provides a way to verify the outcome of the contract in case of any disputes. By following these steps, a secure and transparent consent-based sharing system may be implemented between Web3 nodes. This system enables nodes to control access to their personal data and ensures that data is only shared with the consent of the node that owns it. This feature may be useful for applications that involve the sharing of particularly sensitive personal data, such as healthcare and financial services.

### D. Anonymous Trust

Anonymous trust is yet another important aspect of preferred embodiments of the Web3 nodes disclosed herein. In particular, in some embodiments of the systems and methodologies disclosed herein, the Web3 nodes may be utilized to create a powerful digital ecosystem. This ecosystem may be utilized by consumers and by government, marketplace and commercial organizations to collaborate with authenticity, privacy, secrecy and non-repudiation.

### 1. Authenticity

In the Web3 networks disclosed herein, authenticity, privacy, secrecy, and non-repudiation may be maintained through the use of cryptographic techniques, such as digital signatures, encryption, and decentralized key management systems.

Digital signatures may be used in the Web3 networks disclosed herein to ensure the authenticity of transactions and messages in the network. In a preferred embodiment, a digital signature is a mathematical function that is applied to a message or transaction and acts as a digital fingerprint of the data. By verifying the signature of a message or transaction, other parties in the network can confirm that it was created by the claimed sender and that it has not been altered in transit.

Encryption may be used in the Web3 networks disclosed herein to maintain privacy and secrecy in the network. By encrypting data before it is stored on the network or transmitted between parties, sensitive information may be protected from unauthorized access and tampering. When data is encrypted, it can only be decrypted and read by the party that holds the decryption key.

Decentralized key management systems may be used in the Web3 networks disclosed herein to secure the keys that are used for digital signatures and encryption. By using decentralized key management systems, the risk of key theft or loss may be reduced, and the keys can be managed in a secure and transparent manner.

Non-repudiation may be maintained in the Web3 networks disclosed herein through the use of digital signatures and a decentralized ledger, such as a blockchain. The digital signatures provide proof that a transaction or message was created by the claimed sender, and the decentralized ledger provides a tamper-proof record of all transactions and interactions that take place on the network.

It will be appreciated from the foregoing that, in preferred embodiments of the systems and methodologies disclosed herein, cryptographic techniques and decentralized key management systems may be utilized to maintain authenticity, privacy, secrecy, and non-repudiation in a Web3 network. These techniques may thus be used to provide a secure and transparent foundation for online interactions and transactions.

### E. Identity De-Duplication and Fake ID Elimination

Still another important aspect of preferred embodiments of the Web3 nodes disclosed herein is the use of these nodes in identity di-duplication and the elimination of false or inaccurate IDs. In particular, the unique biometric binding feature of preferred embodiments of the Web3 nodes disclosed herein may be utilized to ensure the accuracy and reliability of identities within a database or data system by providing a means to remove duplicate entries or to consolidate multiple entries relating to the same ID into a single entry, thereby reducing or eliminating inconsistencies or errors.

Such de-duplication may be performed, for example, by using the unique biometric binding feature to compare records within a database and to identifying those that contain similar or identical information. This information may include, for example, personal details such as name, date of birth, address, and other identifying information. Once duplicates have been identified, they may be consolidated into a single, accurate record.

Those skilled in the art will appreciate that identity de-duplication is particularly important in scenarios where accurate and up-to-date information is critical as, for example, in transactions involving financial services, healthcare, and government institutions. For example, in healthcare, the de-duplicating process described above may be applied to patient records to ensure that patient information is accurate and complete, which may improve patient outcomes and reduce medical errors. Those skilled in the art will further appreciate that the unique biometric binding feature of preferred embodiments of the Web3 nodes disclosed herein provides a means by which false or inaccurate IDs may be readily identified and removed from a system or database.

Enrollment may be used as a tool for identity de-duplication in the Web3 networks disclosed herein. The enrollment process typically involves the steps of identity creation, validation, enrollment, comparison, and management.

In a preferred embodiment of the enrollment process, during identity creation, a unique identity is created by a user. This identity is then stored on the blockchain. This identity may be a combination of attributes such as name, email, phone number, and other demographic information. In order to ensure the authenticity of the identity information, the user must provide proof of ownership for the attributes used to create the identity. This proof, which is furnished in the identity validation step, may be in the form of government-issued ID documents, phone numbers, or email addresses. The validated identity is then enrolled on the blockchain, allowing the user to interact with the network using the enrolled identity. It will be appreciated that this process prevents or eliminates the use or generation of falsified identifications.

When a new user tries to enroll an identity, the blockchain network checks the submitted information against existing identities to detect any duplicates. If a duplicate is detected, the enrollment process may be blocked, and the user must resolve the issue before their identity can be enrolled. The enrolled identity can be managed and updated by the user through the Web3 interface. This includes updating personal information, changing passwords, and revoking access to the identity.

In preferred embodiments of the systems and methodologies disclosed herein, the enrollment process allows the Web3 network to ensure that each user has a unique and verifiable identity. Thus, enrollment may be used as a tool to prevent fraud and to improve the security of transactions on the network.

### III. Illustrative Applications

Preferred embodiments of the Web3 nodes disclosed herein, and the systems and methodologies based on these nodes, may be used to solve or address various problems currently known to the art. Some of these problems are described below.

### A. Peer-to-Peer User Agency/Provable Consent

A first example relates to the execution of contracts or agreements, or the signing of documents. The consummation of these activities between autonomous nodes requires hierarchical trust and may be custodial or noncustodial.

For example, the electronic signature and digital transaction management platform known as DocuSign allows individuals and organizations to sign, send, and manage documents electronically, eliminating the need for physical signatures and paper-based processes. In addition to increasing efficiency and enhancing security, it also provides audit trails, document tracking, and other features to help ensure compliance with legal and regulatory requirements. DocuSign is a custodial platform in that it owns the signing keys.

### 1. Problem Statement

Despite its notable advantages, DocuSign also has some infirmities. In addition to the cost and complexity required to incorporate a third party service such as DocuSign into a transaction between two nodes, the expansion of the transaction in this manner also increases the attendant attack surface, thus making the transaction vulnerable to revocation, spoofing, impersonation, account takeover, phishing, insider attack, forging, and other malfeasances.

### 2. Solution Statement

These issues may be addressed through the use of embodiments of the Web3 nodes disclosed herein, and in particular, through the use of the peer-to-peer user agency and provable consent that these Web3 nodes preferably enable. In particular, some embodiments of the Web3 nodes disclosed herein preferably enable signing with a repurposed authentication key.

In a Web3 node, signing with a repurposed authentication key may be enabled by generating the authentication key, integrating the generated key into the Web3 node, using the Web3 API to sign transactions or messages, and verifying the signed data.

In order to sign transactions or messages, a user will need a private key. A new private key may be generated, for example, by using a cryptographic library such as the elliptic curve digital signature algorithm (ECDSA). Once generated, the new key may be integrated into the Web3 node, a process which typically involves adding the private key to the node's keystore or wallet. After integration of the private key into the node, the Web3 API may be utilized to use the private key to sign transactions or messages. Embodiments of the Web3 API may provide a range of methods for signing transactions and messages such as, for example, eth_sign, eth_signTypedData. Finally, verification that the signed data was indeed signed with the repurposed authentication key may be accomplished by using the public key associated with the private key, which can be derived from the private key using a cryptographic library.

One skilled in the art will appreciate that the exact steps to sign with a repurposed authentication key in a Web3 node may vary depending on the specific implementation and the libraries being used. It will typically be important to ensure that the private key is stored securely, since anyone with access to the private key may sign transactions and messages on the user's behalf.

The signing preferably occurs with a non-custodial, hardware embedded, hardware root of trust with attestation. This typically involves generating a key pair, a process by which the hardware root of trust generates a unique key pair consisting of a private key and a public key. The private key is stored securely within the hardware device and is never exposed to the outside world. The hardware root of trust generates an attestation statement, which is a cryptographically signed statement that attests to the authenticity of the key pair. The attestation statement is signed using a trusted third-party attestation authority, such as a trusted platform module (TPM) or a secure element.

The public key is then integrated into the software, such as a Web3 node or an application, that needs to sign transactions or messages. When a transaction or message needs to be signed, the software sends the data to be signed to the hardware root of trust. The hardware device then uses the private key to sign the data and returns the signature to the software. The software can then verify the signature and attestation. In particular, the signature may be verified by using the public key to ensure that it was indeed signed by the hardware root of trust, and the attestation statement may be verified using the trusted third-party attestation authority.

The use of a hardware root of trust in combination with attestation provides several advantages, including enhanced security and privacy. The private key is stored securely within the hardware device and is never exposed to the outside world, making it less susceptible to theft or loss. Additionally, the attestation statement provides a means of verifying the authenticity of the key pair, and the hardware device can be designed to implement additional security features, such as tamper-resistant enclosures and secure boot processes, to further protect the private key.

In some embodiments, the foregoing process may include a cryptographic challenge/response. It may proceed in a zero knowledge and zero trust manner, and may occur with remote physical presence, in a peer-to-peer manner, and with no 3rd party dependencies. This may be achieved, for example, by using multiparty computation (MPC) or threshold signatures. MPC is a technique that enables multiple parties to jointly perform a computation on their inputs, while keeping their inputs private from each other. Threshold signatures is a specific application of MPC, in which a group of parties jointly generate a signature, such that the signature is only valid if a minimum threshold of parties agree.

In a particular, non-limiting embodiment of a process by which such a signing may be achieved using MPC and threshold signatures, the parties generate a shared secret key using MPC. The secret key is divided into multiple shares, each of which is stored on a separate party's device. When a transaction or message needs to be signed, the parties use their shares of the secret key to jointly generate a signature in a way that keeps the secret key private from each other. The signature is only valid if a minimum threshold of parties agree. The signature can be verified using the public key, which can be publicly available.

By using MPC and threshold signatures, signing can be achieved in a zero-knowledge and zero trust manner, with remote physical presence, in a peer-to-peer manner, and with no 3rd party dependencies. The parties can sign transactions or messages without revealing their secret key or relying on a trusted third party. Additionally, the signature is only valid if a minimum threshold of parties agree, ensuring that the signature cannot be generated without the cooperation of a sufficient number of parties.

In some embodiments, the foregoing solution may have other features or benefits. These may include, but are not limited to, lightweight, high-assurance agency that provides cryptographically provable consent for browser/web transactions. In such implementations, Web Authn may be utilized to expose HRoT via a browser with hardware attestation. These may also include a decentralized persistent identity layer, where blockchain is used to store a decentralized public identity (for example, a user and public HRoT key) and key value pairs and obtain a public key to verify a WebAuthn signature. These may further include a decentralized identifier.

The foregoing process may be implemented using a combination of smart contracts and decentralized authentication. In a particular, non-limiting embodiment of such a process, a smart contract is set up on the Web3 network that defines the rules and logic for the agency. The contract may define the terms of consent, such as the type of transactions that require consent, and the parties involved. Next, a decentralized authentication solution, such as a decentralized identity protocol, may be utilized to securely manage and verify the identity of the parties involved in the transaction. This helps to ensure that only authorized parties are able to access the consent process and sign transactions. Once the identity of the parties has been verified, the parties can then sign the transaction using their private key. This creates a cryptographically secure and tamper-proof record of the consent, which can be stored on the Web3 network and referenced in future transactions. Once the consent has been provided and recorded, the transaction can then be executed on the Web3 network according to the rules defined in the smart contract.

By using this approach, a lightweight, high-assurance agency can be implemented in a Web3 transaction that provides cryptographically provable consent for browser/web transactions. This ensures that the transactions are secure, tamper-proof, and can be trusted by all parties involved.

### B. Multi-Channel Biometric Bind

A second example relates to the management of public keys in a decentralized ecosystem. When a user connects to decentralized ecosystem from different devices, each device has a HRoT key to access the ecosystem, and each key is protected by a biometric or PIN bind. The user may use a first biometric match or enter a screen lock pin before the device makes the private key available for authentication to a backend resource.

### 1. Problem Statement

The issue then arises as to how a decentralized ecosystem can manage the related verification (public) keys for use in the associated cryptographic challenge/response.

### 2. Solution Statement

This issue may be addressed in the Web3 nodes disclosed herein through the addition of a key/value pair to an identity blockchain for each new device that is enrolled. Subsequent authentication is then an OR operation performed over all the keys with the same value (name).

### C. API Simplification

A third example relates to the complexity of API structures. These structures provide a mechanism for passing data or control across domain boundaries. In web services, API is an abstraction layer between frontend client requests and backend services. However, these structures present several problems in the context of a decentralized system of the type disclosed herein.

### 1. Problem Statement

For example, API structures present security issues, since they are very uniform (JSON, etc.) and thus present a unform attack surface to external cyber-crime. Such attacks may include injection attacks, such as SQL injection or script injection, where malicious payloads are injected into API requests in order to compromise the server or steal data, or Denial of Service (DOS) attacks, where the API is flooded with a large number of requests in order to overload the server and make it unavailable.

These structures also entail substantial duplication, with each exposed service possibly presenting its own edge functions, termination, encryption, authentication, and limiting features. These structures also include unnecessary structures; for example, the API may facilitate access to multiple services and may thus impose uniform sequencing that is optimized for the most complex service, thereby imposing excessive friction or complexity on less constrained services.

API structures also present issues of tight coupling. Tight coupling occurs when the client component that consumes an API is highly dependent on the structure and behavior of the API. This means that any changes to the API, such as changes to its parameters, data structures, or behavior, can have a significant impact on the client component. Tight coupling can make it difficult to maintain and evolve an API, as any changes to the API may require corresponding changes to the client component, which can be time-consuming and expensive. It can also make it difficult to reuse an API, as the client component may be tightly tied to the structure and behavior of the API, making it difficult to use the API in other contexts.

In some of the decentralized systems disclosed herein, the user application, the API and the backend service are tightly coupled. Consequently, when upgrades or changes are introduced, duplicated endpoints may be required until all users are up to date. If many services are using the same API, this requires coordination.

API structures also present issues of blockchain compatibility. In a decentralized ecosystem, different blockchain systems need to to interact and work together seamlessly. When compatibility is an issue, it can create challenges for decentralized applications (dApps) and smart contracts that are built on different blockchains, as they may not be able to communicate and transfer data effectively.

APIs represent a significant challenge in achieving blockchain compatibility. In a centralized ecosystem, APIs are typically provided by a central authority and are used to access data and services. However, in a decentralized ecosystem, there may be multiple APIs provided by different parties, each with its own set of rules and limitations. Consequently, APIs can become a bottleneck or chokepoint that restricts the flow of information and transactions. For example, if a dApp built on one blockchain relies on an API provided by a central authority on another blockchain, that central authority can effectively control the flow of information and transactions between the two systems. This can create a single point of failure that can compromise the security and stability of the entire ecosystem.

Furthermore, the lack of standardization and interoperability between different blockchains can also make it difficult to achieve compatibility. This can result in fragmentation and isolated pockets of activity within the ecosystem, which can limit its potential for growth and innovation.

APIs also impose a financial burden on decentralized ecosystems. This burden may manifest as usage fees, integration costs, vendor lock-in and maintenance costs. For example, some API providers charge usage fees based on the number of requests made or the amount of data transferred. These fees can quickly add up, especially for small transactional ecosystems that have limited resources and need to make many API requests.

There are also integration costs involved in integrating APIs into an ecosystem. In particular, APIs can require significant development and testing effort, which can be costly for small transactional ecosystems. This can be especially true if the APIs are proprietary and require special software or licensing fees.

There are also vendor lock-in fees associated with APIs. In particular, if a small transactional ecosystem relies on a proprietary API, the ecosystem may become locked into using that particular provider, thus increasing its dependence on the provider. This can limit their ability to switch to a different provider or integrate with other systems.

APIs also present maintenance costs. Keeping an API integration up-to-date and functioning correctly can require ongoing maintenance and support. Small transactional ecosystems may not have the resources to provide this level of support, and may be forced to pay for external help.

In addition, relying on APIs for essential functionality can also pose a risk for small transactional ecosystems. If the API provider experiences downtime or goes out of business, the ecosystem may be unable to function, leading to lost revenue and potential legal disputes.

### 2. Solution Statement

The foregoing issues may be dealt with through the adoption of a uniform transaction messaging format across the entire decentralized ecosystem and the implementation of a loosely coupled pub/sub style architecture.

In some embodiments, the solution may include the imposition of blockchain cryptography on transaction messaging. Blockchain cryptography may help to secure the data being transmitted between the participants in the blockchain network, thus helping to ensure the privacy and confidentiality of the transactions and the integrity of the data being transmitted. Possible cryptographic techniques that may be utilized in the application of blockchain cryptography to transaction messaging may include, but are not limited to, the use of public key cryptography, hashing and digital signatures.

In some embodiments, the blockchain cryptography utilized may support zero-knowledge traffic authorization or validation, using the public key stored on the identity blockchain. This approach provides the ability to authenticate and validate information without revealing the underlying data, thus allowing for the verification of information without exposing the data itself to the verifier. In the context of traffic authentication, this means that a verifier can verify the authenticity of a message or transaction without actually seeing the contents of the message or transaction. Instead, the verifier is given a proof or a certificate that certifies the validity of the message or transaction. The proof or certificate is generated by a trusted party, such as a certificate authority, and is based on cryptographic techniques such as zero-knowledge proofs.

It will be appreciated that the use of zero-knowledge traffic authentication may be especially useful in situations where privacy and security are important, such as in the transfer of sensitive financial or medical information. By enabling authentication and validation without revealing the underlying data, zero-knowledge traffic authentication helps to increase the privacy and security of data being transmitted. In addition, zero-knowledge traffic authentication can also help to improve scalability and efficiency in systems where large amounts of data need to be verified. By reducing the amount of data that needs to be transmitted and processed, zero-knowledge traffic authentication can help to reduce the overhead and latency associated with data verification.

In a preferred embodiment, the solution is compliant with NIST 800-207 to protect each resource with a dedicated policy enforcement point (PEP). A PEP is a component that enforces security policies for a specific resource. By having a dedicated PEP for each resource, the solution can ensure that the correct policies are applied to each resource, and that the policies are enforced consistently and accurately. This helps to reduce the risk of policy enforcement errors, which could result in security breaches or other types of incidents.

To implement such a NIST SP 800-207 compliant solution with dedicated PEPs for each resource, the solution should include the following components:
(a) a central policy management component that defines and manages the security policies for all resources;
(b) set of dedicated PEPs for each resource, responsible for enforcing the security policies that have been defined for that resource;
(c) a secure communication channel between the central policy management component and the PEPs, to ensure that the policies are distributed and enforced consistently and accurately; and
(d) a logging and auditing component that records all policy enforcement activities and provides visibility into the enforcement of security policies.

The policies associated with each PEP may be published as smart contracts and may be enforced by the dedicated PEP. Such enforcement may be automated, event-triggered or manual.

In the case of automated enforcement, the PEP may be programmed to automatically enforce the policy when a request is made to access a resource. For example, if the policy states that a user must be authenticated before accessing a resource, the PEP can automatically enforce the authentication process before granting access.

In the case of event-triggered enforcement, the PEP may be programmed to enforce policies when specific events occur. For example, if the policy states that a resource must be encrypted before being transmitted over the network, the PEP can enforce this policy when a request is made to transmit the resource.

In the case of manual enforcement, the PEP may be configured to allow manual enforcement of policies. For example, if the policy states that access to a resource must be approved by a security administrator, the PEP can enforce the policy by requiring manual approval before granting access.

The enforcement of policies by a PEP may be performed by executing the code in the smart contract. The smart contract defines the rules and conditions that must be met in order to access the resource, and the PEP ensures that these conditions are met before granting access. Using smart contracts to define and enforce policies ensures that policies are consistently enforced, and that the policies are transparent and auditable. This helps to increase the security and reliability of the system, and to reduce the risk of security breaches or other types of incidents.

The foregoing solution provides various benefits. For example, these solutions may be implemented with a software-defined architecture, thus imparting more flexibility, scalability, and programmability to the solution, since the functionality can be easily changed or updated by modifying the software.

These solutions may also be utilized to implement custom behavior. In particular, specific actions, responses, or interactions may be programmed into the solution to meet the specific requirements or preferences of an associated user or organization. Custom behavior may be utilized to extend or modify the functionality of the solution, or to tailor the solution to meet specific business needs. For example, custom behavior may be utilized to implement specific business processes, to add new features or functionality, or to modify the user interface to meet specific requirements. In any associated hardware used to implement the solution, custom behavior may be utilized to modify the way a device operates, to add new capabilities, or to change the default settings.

Custom behavior may be implemented in the solution through the use of suitable programming languages, configuration files, or specialized tools. This allows organizations or entities to customize the solution to meet their specific needs, while still taking advantage of the underlying technology.

Suitable decoupling (that is, the separation of two or more components or systems in the technology architecture) may be utilized in the foregoing solutions. Decoupling may increase the flexibility, scalability, and resilience of the system, and may reduce the impact of changes or failures in one component on other components.

Decoupling may be achieved in various ways in the foregoing solutions. For example, decoupling may be implemented via the IF/THEN policy architecture. In this architecture, policies are defined in terms of IF/THEN statements, which specify the conditions under which specific actions or responses should be taken. For example, an IF/THEN policy might specify that “IF a user requests access to a resource, THEN the user must be authenticated”. The policy defines the conditions that must be met (user authentication) in order for the action to be taken (granting access to the resource).

One skilled in the art will appreciate that, in an IF/THEN policy architecture, the enforcement of policies is decoupled from the underlying system components. The policies are defined in a separate layer, and the enforcement of the policies is performed by a dedicated policy enforcement point (PEP), which acts as an intermediary between the user and the resource. This decoupling of policies from system components allows for increased flexibility, as policies can be easily changed or updated without affecting the underlying components. It also allows for more centralized and automated enforcement of policies, leading to increased security and reliability. By using an IF/THEN policy architecture, organizations can implement decoupling in their technology systems, allowing them to achieve increased flexibility, scalability, and resilience, while also reducing the risk of security breaches or other types of incidents.

Various other forms of decoupling may be implemented in the foregoing solutions. For example, decoupling may take the form of component separation. This type of decoupling involves physically separating different components of the system, so that changes or failures in one component do not impact other components. For example, separating a database from the application layer can reduce the risk of changes or failures in the database affecting the application.

Decoupling may also be implemented through the suitable use of abstraction layers. This involves creating abstraction layers between different components of a system, so that changes or failures in one component are isolated from other components. For example, creating a logical layer between the database and the application can help to isolate the application from changes or failures in the database.

Decoupling may also be implemented through the user of a service-oriented architecture (SOA). This approach involves designing a system as a set of services, which can be called by other components in the system. This allows for decoupled communication between components, as each component only needs to know how to call the services it requires, rather than how the services are implemented.

Decoupling may also be implemented through the use of a microservices architecture. This approach involves building a system as a set of small, independently deployable services, which can be combined to form a complete system. This allows for decoupled development and deployment of services, as well as increased resilience and scalability, as failures or changes in one service are isolated from other services.

Decoupling may also be implemented through the use of an event-driven architecture (EDA). This involves designing the system to respond to events, rather than direct requests. This allows for decoupled communication between components, as each component only needs to know how to respond to specific events, rather than how to directly communicate with other components.

One skilled in the art will appreciate that decoupling may be achieved in the solutions described herein through a combination of the foregoing approaches, and that the specific approach used may depend on the requirements and constraints of the system being designed.

The foregoing solutions are preferably implemented as FPGA (Field Programmable Gate Array) compatible solutions. FPGAs are well known to the art, and the ability of these integrated circuits to be programmed and reconfigured post manufacturing has led to their application in fields such as digital logic, data processing, and high-performance computing. Here, FPGA compatibility refers to the ability of these solutions to interface with an FPGA in a way that allows the FPGA to control or process the data being passed between the two components. This typically involves meeting specific electrical and protocol standards, such as input/output (I/O) voltage levels and data transfer rates. Ensuring that components of the solution are FPGA compatible allows these solutions to leverage the flexibility and programmability of FPGAs to build custom solutions that meet specific needs and requirements.

By way of example and not limitation, IF conditions may be implemented in the solutions disclosed herein as finite state machine (FSM) or dependency lists in FPGA hardware to accomplish flow-through policy enforcement. An FSM is a model of computation that can be used to describe the behavior of a system as a series of states and transitions between those states. An FSM can be used to implement an IF/THEN policy in FPGA hardware by representing each policy condition as a state, and each action to be taken as a transition between states. For example, consider a policy that specifies that “IF a user requests access to a resource, THEN the user must be authenticated”. In this case, the FSM could represent the states “user request received” and “user authenticated”, and the transition between these states would represent the enforcement of the policy.

A dependency list is another approach that can be used to implement IF conditions in FPGA hardware. A dependency list represents the dependencies between different elements of a system, and can be used to implement policies by specifying the order in which specific actions must be taken. For example, consider the same policy as above: “IF a user requests access to a resource, THEN the user must be authenticated”. In this case, the dependency list would specify that the user must be authenticated before access to the resource can be granted.

Implementing IF conditions as finite state machines or dependency lists in FPGA hardware ensures that policies are enforced in a consistent and reliable manner. This is true even in high-speed and high-throughput computing environments.

### D. Decentralized Policy Enforcement

A fourth example relates to policy management. Policy management is the process of defining, implementing, and enforcing policies that govern the behavior of the devices and users that are connected to the network. A network policy defines what actions are allowed or prohibited on the network, and helps to ensure that the network is used in a secure and efficient manner.

Policy management in a network environment typically involves the following steps:
(a) Policy definition: Defining policies that specify the behavior that is allowed or prohibited on the network.
(b) Policy implementation: Implementing policies by configuring network devices such as routers, switches, and firewalls to enforce the policies.
(c) Policy enforcement: Enforcing policies to ensure that the network is used in accordance with the policies. This may involve logging and alerting when policies are violated, and taking corrective action to prevent future violations.
(d) Policy monitoring: Monitoring the network to ensure that policies are being followed, and to identify any potential violations.
(e) Policy revision: Revising policies as needed to ensure that they continue to meet the changing needs and requirements of the network.

Policy management in a network environment is critical to ensuring that the network is used in a secure and efficient manner. By defining and enforcing policies, the risk of security breaches and data loss is minimized. This also ensures that the network is used in a manner that is consistent with business objectives and regulatory requirements.

### 1. Problem Statement

The systems and methodologies disclosed herein preferably comprise, or are implemented on, decentralized networks. As such, these networks have no centralized directory. This makes group policy management, in the sense of applying group policy to active directory groups, difficult if not impossible.

### 2. Solution Statement

The foregoing problem may be addressed in the systems and methodologies disclosed herein by distributing policy as a set of smart contracts, thus ensuring that all participants in the network follow the same set of rules and guidelines. As self-executing contracts with the terms of the agreement directly written into lines of code, smart contracts can be used to encode business logic and enforce policies in a transparent and tamper-proof manner.

Policies may be distribute in a distributed network as a set of smart contracts using various means. In a preferred embodiment of the systems and methodologies disclosed herein, policy distribution is achieved via the following steps:
(a) Policy definition: Define the policies that govern the behavior of the network participants.
(b) Smart contract creation: Write the policies into a smart contract using a programming language such as, for example, Solidity or Chaincode.
(c) Smart contract deployment: Deploy the smart contract onto the distributed network, so that it is accessible to all participants.
(d) Policy enforcement: The smart contract will automatically enforce the policies defined in the contract whenever a transaction is processed on the network.
(e) Policy revision: If changes to the policies are needed, the smart contract can be updated, and the changes will be automatically enforced on the network.

Distributing policies as a set of smart contracts in a distributed network can help ensure that all participants follow the same set of rules and guidelines, and that policies are transparent and tamper-proof. By automating the enforcement of policies, smart contracts can also help to reduce the risk of human error, increase efficiency, and enhance the security and reliability of the network.

The foregoing problem may also be addressed in the systems and methodologies disclosed herein by enforcing the policy in resource specific PEPs. This may involve, for example, assigning policies to resources, implementing PEPs, connecting PEPs to PDP, and monitoring and evaluating the implementation. In one specific, non-limiting example, this may involve the steps of policy definition, assignment of policies to resources, implementation of PEPs, connection of PEPs to PDP (policy decision point), and monitoring or evaluation. These steps are described in greater detail below.

Define policies: The first step is to define policies for the network. These policies may include access control policies, data privacy policies, and security policies, among others. The policies are preferably well-defined and written in a way that can be enforced by the PEPs.

Assign policies to resources: Once the policies have been defined, they need to be assigned to specific resources within the network. This step typically involves identifying the resources that need to be protected and mapping the policies to those resources.

Implement PEPs: Policy Enforcement Points (PEPs) are the components of the network responsible for enforcing the policies. For each policy, a PEP should be implemented that can enforce that policy at the resource level. The PEPs are preferably capable of receiving policy decisions from the PDP and enforcing those decisions at the resource level.

Connect PEPs to PDP: The PEPs and the Policy Decision Point (PDP) are preferably connected in a way that enables the PDP to send policy decisions to the PEPs for enforcement. The PEPs are preferably able to receive and process policy decisions from the PDP, and enforce those decisions at the resource level.

Monitor and evaluate: Finally, the implementation of PEPs are preferably monitored and evaluated to ensure that the policies are being enforced correctly and effectively. This step may involve gathering data on resource access, monitoring resource usage, and evaluating the effectiveness of the policies.

The foregoing solution enables policy enforcement in edge devices, including resource constrained devices such as sensors, by providing a decentralized and distributed approach to policy enforcement that may improve the efficiency, scalability, and security of the system.

In conventional policy enforcement architectures, the enforcement of policies often occurs at a central point in the network. This can create performance and scalability limitations, especially in large, decentralized networks with many edge devices. By implementing PEPs that are specific to each resource in the network, the enforcement of policies can be distributed across the network, with each PEP responsible for enforcing the policies for its corresponding resource. This may reduce the processing and communication overhead of policy enforcement and allow policies to be enforced efficiently, even on resource-constrained devices such as sensors.

In addition, resource-specific PEPs can provide more fine-grained control over policy enforcement, allowing policies to be tailored to the unique requirements and capabilities of each resource. For example, a resource-constrained sensor may have limited processing and memory capabilities, so its PEP can be designed to enforce policies in a more efficient and lightweight manner.

Furthermore, implementing PEPs at the resource level can also help to improve security and privacy, as policies can be enforced closer to the resource, reducing the risk of policy decisions being intercepted or tampered with in transit.

The enforcement of policy in edge devices has several aspects. These typically include access control, application rules, business rules, and regulatory obligations, each of which is described in greater detail below.

a. Access Control

Access control is a key aspect of the enforcement of policy in edge devices, and refers to the process of determining who is allowed to access a particular resource and what actions they are allowed to perform on that resource.

In edge devices, access control is typically implemented as part of the enforcement of policies by Policy Enforcement Points (PEPs). The PEPs are responsible for enforcing the policies that determine who is allowed to access a particular resource and what actions they are allowed to perform. When a request is made to access a resource, the PEP associated with that resource evaluates the request against the policies that have been assigned to that resource. If the request is in compliance with the policies, the PEP grants access to the resource. If the request is not in compliance with the policies, the PEP denies access to the resource.

Access control policies can be used to enforce a wide range of security and privacy requirements in edge devices. For example, access control policies can be used to:
(a) Limit access to sensitive resources to only authorized users;
(b) Ensure that only authorized devices can access a particular resource;
(c) Prevent unauthorized access to resources such as sensors and actuators;
(d) Control the type of actions that can be performed on a particular resource; and
(e) Limit the amount of data that can be accessed or transmitted.
   b. Application Rules

Application rules are involved in the enforcement of policy in edge devices by providing a set of specific instructions that define how policies are to be enforced for a particular application or resource. Application rules are used by PEPs to determine what actions to take when a request is made to access a particular resource.

Application rules can be used to specify the types of actions that are allowed or prohibited, such as the type of data that can be accessed, the type of processing that can be performed, and the type of communication that can be initiated. Application rules can also specify the conditions under which specific actions are allowed or prohibited, such as the time of day, the location of the device, or the identity of the user making the request.

When a request is made to access a resource, the PEP associated with that resource evaluates the request against the policies and application rules that have been assigned to that resource. If the request is in compliance with the policies and application rules, the PEP grants access to the resource. If the request is not in compliance with the policies and application rules, the PEP denies access to the resource.

Application rules provide a flexible and fine-grained approach to policy enforcement in edge devices, allowing policies to be tailored to the specific requirements of each application or resource. They also help to simplify the implementation of policies, as they provide a clear and concise set of instructions for the PEPs to follow when enforcing policies.

c. Business Rules

Business rules are involved in the enforcement of policy in edge devices by providing a set of specific instructions that define how policies are to be enforced in accordance with the business requirements and objectives of an organization. Business rules provide the foundation for the policies that are used to enforce access control and security in edge devices.

Business rules can specify a wide range of requirements, such as the types of devices that are allowed to access a particular resource, the types of actions that are allowed or prohibited, the conditions under which specific actions are allowed or prohibited, and the types of data that can be accessed or transmitted. Business rules can also specify the priority of different policies, allowing organizations to balance security and privacy requirements with the need for access to resources and data.

When a request is made to access a resource, the PEP associated with that resource evaluates the request against the policies and business rules that have been assigned to that resource. If the request is in compliance with the policies and business rules, the PEP grants access to the resource. If the request is not in compliance with the policies and business rules, the PEP denies access to the resource.

Business rules provide a flexible and powerful approach to policy enforcement in edge devices, allowing organizations to tailor their policies to their specific business requirements and objectives. They also help to simplify the implementation of policies, as they provide a clear and concise set of instructions for the PEPs to follow when enforcing policies.

d. Regulatory Obligations

Regulatory obligations play a critical role in the enforcement of policy in edge devices. Regulatory obligations refer to the legal and regulatory requirements that organizations must comply with when deploying and using edge devices. Regulatory obligations may include privacy laws, data protection laws, security standards, and industry-specific regulations. They may specify a wide range of requirements, such as the types of data that can be collected and stored, the types of processing that can be performed, the types of communication that can be initiated, and the types of security measures that must be in place.

When enforcing policies in edge devices, organizations must typically take into account their regulatory obligations to ensure that they are complying with the applicable legal and regulatory requirements. For example, if an organization is required to comply with privacy laws that limit the types of data that can be collected and stored, the organization must implement policies that ensure that these requirements are met.

Regulatory obligations play a critical role in shaping the policies that are used to enforce access control and security in edge devices. They provide a clear and concise set of requirements that organizations must comply with when deploying and using edge devices, and they help to ensure that the policies used to enforce access control and security are aligned with the legal and regulatory requirements.

### E. Anonymous Trust

A fifth example relates to anonymous trust. Anonymous trust refers to a type of trust relationship that is established in a network without the need for identity authentication. In an anonymous trust relationship, the parties involved do not need to verify each other's identities in order to communicate or exchange information.

Anonymous trust is often used in situations where identity authentication is not practical, such as in large-scale networks where the number of nodes is too large to effectively manage identities. In these scenarios, anonymous trust provides a mechanism for enabling secure communication and data exchange without the need for identity authentication.

For example, in an anonymous trust relationship between two nodes in a network, the nodes can securely exchange data and information without the need for either node to know the identity of the other. Instead, the nodes rely on a common trust anchor, such as a certificate authority, to provide a trusted foundation for the communication.

Various methods exist for implementing anonymous trust in a centralized network. For example, in a network where nodes share a common root and rely on a shared directory, anonymous trust can be implemented through the use of hierarchical digital certificates. In this type of system, a trusted root certification authority (CA) issues digital certificates to the nodes in the network, and the nodes can use these certificates to establish secure communication with each other.

To preserve anonymity in this type of network, the digital certificates issued by the root CA can be designed to only include a unique identifier for each node, and not the node's actual identity. This way, when nodes communicate with each other, they can use the unique identifier in their digital certificate to authenticate each other and establish secure communication, without revealing their true identities.

Additionally, to enhance the security of the network and to prevent eavesdropping or tampering with the communication between nodes, the nodes can use encryption and secure communication protocols, such as SSL/TLS, to encrypt the data being transmitted between them.

Similarly, in a network that utilizes X.509 certificates (available, for example, from VeriSign), anonymous trust can be implemented through the use of an anonymous certificate. An anonymous certificate is a digital certificate that does not include the identity of the certificate holder in its subject field, but rather includes a unique identifier in its subjectAltName field. The certificate can be used to establish secure and encrypted communication between two parties, while still preserving the anonymity of the certificate holder.

To use an anonymous certificate, the client first generates a request for an anonymous certificate from a trusted CA. The request typically includes a public key but does not include the identity of the client. The trusted CA then issues the anonymous certificate, signed with the CA's private key, and return it to the client. Once the client has the anonymous certificate, it can use it to establish secure communication with a server that trusts the same CA. The server validates the certificate and, if it is valid, uses the public key in the certificate to establish a secure and encrypted connection with the client.

In a network where there is a common platform to broker deals, anonymous trust can be implemented through the use of multi-party computation (MPC) protocols. MPC protocols are cryptographic techniques that allow multiple parties to compute a function together, without revealing their inputs to each other. In networks having a common platform to broker deals, MPC protocols can be used to preserve the anonymity of the parties involved in the transaction. For example, two parties can use MPC to agree on the terms of a deal without revealing their identities or the details of the deal to the common platform. This way, the platform can act as a neutral third-party broker, but the identities of the parties involved in the transaction remain anonymous.

### 1. Problem Statement

The implementation of anonymous trust is more complicated in a decentralized network. Such networks typically lack a shared infrastructure to establish sufficient trust to facilitate a remote transaction, and similarly lack a shared directory where the nodes have a common root. Such networks also typically lack an expensive hierarchical trust (e.g., a trusted root CA) or a common platform to broker a deal.

### 2. Solution Statement

It has now been found that the foregoing problems may be addressed through a combination of elements. These may include one or more of an identity chain, verifiable claims, software defined PEPs, and the use of DIDs. Each of these elements is described further below.

a. Identity Chains

In some embodiments of the systems and methodologies described herein, anonymous trust can be implemented through the use of identity chains and pseudonyms. A pseudonym is a false name used by an individual in place of their real name, allowing them to preserve their anonymity while still establishing trust in a network.

In a network using identity chains, individuals can use pseudonyms as their identities, and the identity chains can be used to manage and verify the associations between these pseudonyms and the real-world identities of the individuals. This way, the individuals can participate in the network and engage in transactions without revealing their real-world identities, while still maintaining the trust and accountability provided by the identity chains.

b. Verifiable Claims

In some embodiments of the systems and methodologies described herein, anonymous trust can be implemented through the use of verifiable claims, and in particular, through the use of a verifiable claims system which is designed to only include necessary information, while preserving the privacy of individuals.

Verifiable claims are statements that can be independently verified by a third party, such as a government, a financial institution, or a trusted organization. In a network using verifiable claims, individuals can make claims about their identity, such as their age, employment status, or educational background, without revealing their personal information.

To preserve the anonymity of individuals in this type of network, the verifiable claims system can be designed to only include the minimum necessary information needed to establish trust, while not revealing the individuals' personal information. For example, a claim about an individual's age may only include their birth year, without revealing their full date of birth.

c. Software Defined PEPs

In some embodiments of the systems and methodologies described herein, anonymous trust can be implemented through the use of software defined PEPs, and in particular, by designing the PEPs to only enforce necessary policies, while preserving the privacy of individuals.

A PEP is a component in a network that is responsible for enforcing security policies. In a network using software-defined PEPs, these policies can be dynamically configured and changed based on the needs of the network.

To preserve the anonymity of individuals in this type of network, the PEPs can be designed to only enforce necessary policies that are relevant to the transactions being performed, while not revealing the individuals' personal information. For example, a PEP may enforce a policy requiring the use of encryption to protect sensitive information, without revealing the specifics of the information being protected.

d. DIDs

In some embodiments of the systems and methodologies described herein, anonymous trust can be implemented through the use of DIDs, and in particular, by designing the DIDs to only include necessary information, while preserving the privacy of individuals.

A DID is a unique identifier that is associated with a specific individual or entity, and is stored on a decentralized network. In a network using DIDs, individuals can use their DIDs as their identities, and the network can be used to manage and verify the associations between these DIDs and the real-world identities of the individuals.

To preserve the anonymity of individuals in this type of network, the DIDs can be designed to only include the minimum necessary information needed to establish trust, while not revealing the individuals' personal information. For example, a DID could only include the individual's name, without revealing their full address or contact information.

### 3. Miscellaneous

Various other tools and features may be utilized in addition to, or in combination with, the foregoing items to implement anonymous trust in the decentralized networks described herein. For example, the network may also use encryption and secure communication protocols to protect the privacy of the individuals and the details of their transactions, further enhancing the security and anonymity of the network.

### F. Converged Stack

A sixth example relates to the network infrastructure common to packet-based networks, and the attacks they are subject to.

Packet-based networks are commonly used in modern computer networks, including local area networks (LANs), wide area networks (WANs), and the Internet. The network infrastructure that is utilized to process packets includes a combination of hardware and software components. For example, routers are responsible for forwarding packets between different networks and for determining the best path for the packets to take. Switches are used to connect devices within a single network and to control the flow of network traffic. Firewalls are used to secure networks by controlling the flow of incoming and outgoing network traffic, and can be used to block unauthorized access and to enforce security policies. Load balancers are used to distribute network traffic across multiple servers, to ensure that the network can handle large volumes of traffic and to provide redundancy in case of server failure. Security gateway devices are used to protect networks from potential threats by examining and controlling the flow of network traffic, and can be used to provide services such as intrusion detection and prevention, VPN access, and web filtering. Network address translation (NAT) devices are used to translate private IP addresses used within a network to public IP addresses that are used on the Internet. Network monitoring and management tools are used to monitor the performance of the network, to identify and resolve issues, and to provide visibility into network activity. These components work together to process packets as they move through the network, routing them to their destination and ensuring the security and reliability of the network.

### 1. Problem Statement

While modern networks have evolved to process packets in the infrastructure, this infrastructure also serves as a point of attack. In particular, Distributed Denial of Service (DDoS) and Directed Reflection Denial of Service (DRDOS) attacks can occur at various points in a network infrastructure, depending on the type of attack being launched, and can have a significant impact on network performance and availability.

Thus, for example, such attacks can target network devices, such as routers, switches, and firewalls, in order to overwhelm them and prevent them from functioning properly. Such attacks can also target servers, such as web servers, email servers, and database servers, in order to overwhelm them and prevent them from responding to legitimate requests. Such attacks can also target the application layer of a network, by sending large amounts of traffic specifically designed to exploit vulnerabilities in the application software. Such attacks can also target DNS servers, in order to prevent them from resolving domain names and disrupt access to websites and other online resources. Such attacks can target ISPs, in order to disrupt their network and prevent them from providing services to their customers.

### 2. Solution Statement

The foregoing problems may be addressed in the systems and methodologies disclosed herein through the use of converged stacks, also known as converged infrastructure. In such an infrastructure, multiple technology components, such as computing, storage, and networking, may be integrated into a single, unified system. Converged stacks simplify IT infrastructure and increase operational efficiency by providing a unified management platform for all components.

In a converged stack, each component is designed to work together, with common management tools, hardware, and software. This integration may help reduce complexity, improve performance, and simplify administration. By providing a single, integrated solution, converged stacks may help organizations reduce the time and resources required to manage their IT infrastructure. Converged stacks also improve scalability, reliability, and security, and may be utilized in cloud computing environments to quickly and easily provision resources as needed.

In preferred embodiments, the converged stack includes n IP layer and higher layer TCP/HTTP/Application can enable policy coherence optimized for the application by leveraging application-aware networking, centralized management, traffic classification and prioritization, quality of service (QOS), and threat prevention. Each of these features is described in greater detail below. Together, these features can provide advanced capabilities that can help optimize policy coherence for the application. By integrating multiple technology components into a single, unified system, a converged stack can help organizations reduce the time and resources required to manage their IT infrastructure, freeing up time and resources for other important projects.

a. Application-Aware Networking

By including both the IP layer and the higher layer TCP/HTTP/Application, a converged stack can provide application-aware networking capabilities. This means that the network is able to understand the underlying application protocols and behavior, and can use this information to make informed decisions about how to manage network traffic.

b. Centralized Management

A converged stack can provide centralized management of network security policies, making it easier to enforce consistent security measures across a distributed network. This can help optimize policy coherence for the application by ensuring that all network devices are configured the same way, and by providing a single, unified view of network activity.

c. Traffic Classification and Prioritization

By integrating the IP layer and higher layer TCP/HTTP/Application, a converged stack can provide advanced traffic classification and prioritization capabilities. This can help optimize policy coherence for the application by ensuring that critical applications receive the bandwidth and resources they need, while less critical traffic is managed more effectively.

d. Quality of Service (QoS)

By including the IP layer and higher layer TCP/HTTP/Application, a converged stack can provide advanced Quality of Service (QoS) capabilities. This can help optimize policy coherence for the application, and can help prevent DDoS and DRDoS attacks, by ensuring that critical applications receive the bandwidth and resources they need, while less critical traffic is managed more effectively.

e. Threat Prevention

A converged stack can include advanced security features, such as intrusion detection and prevention systems, that can help prevent DDoS and DRDOS attacks. For example, these systems can detect and block traffic that exceeds certain thresholds, preventing malicious traffic from overwhelming network devices.

f. Traffic Analysis

By including both the IP layer and the higher layer TCP/HTTP/Application, a converged stack can provide advanced traffic analysis capabilities. This means that the network is able to understand the underlying application protocols and behavior, and can use this information to detect and prevent malicious traffic. For example, the network can detect and block traffic that exceeds certain thresholds, preventing malicious traffic from overwhelming network devices.

g. Load Balancing

By integrating the IP layer and higher layer TCP/HTTP/Application, a converged stack can provide advanced load balancing capabilities. This can help prevent DDoS and DRDoS attacks by distributing traffic across multiple network devices, reducing the risk that a single device will be overwhelmed by malicious traffic.

h. Network Segmentation

A converged stack can provide network segmentation capabilities that can help prevent DDoS and DRDOS attacks. For example, by segmenting the network into different subnets or virtual LANs (VLANs), the network can prevent malicious traffic from spreading across the entire network, reducing the risk of a widespread attack.

### G. Non-Custodial Session Tokens

A seventh example relates to session tokens. Session tokens are pieces of information that are used to identify a user's session with a website or application. They are commonly used to store user authentication information and session state data, such as the items a user has added to a shopping cart. The token is typically stored on the user's device, such as in a cookie, and sent back to the server with each request.

Session tokens are used to maintain the state of a user's session and to ensure that the user is who they claim to be. When a user logs into a website or application, a unique session token is generated and stored on the user's device. This token is then sent back to the server with each request made during the session, allowing the server to identify the user and maintain the state of the session.

### 1. Problem Statement

Despite their advantages, session tokens also present some infirmities. For example, session tokens are signed by the relying party. Consequently, stolen session tokens can pose a serious security risk, as they allow attackers to gain unauthorized access to a user's account and potentially sensitive information. Stolen tokens may be utilized by malfeasers to perpetrate session hijacking, impersonation, data theft, account takeover, and other such acts.

The security threat posed by stolen session tokens extends beyond the account the token is associated with. In particular, stolen session tokens can enable lateral movement exploits in a cyber or ransomware attack by allowing an attacker to gain access to multiple systems within a network using a single compromised account. This can be especially dangerous if the account has elevated privileges, as the attacker can then use these privileges to move laterally across the network and gain access to sensitive information and systems.

In a ransomware attack, the attacker can use a stolen session token to move laterally across the network, infecting multiple systems and potentially causing widespread damage. In a cyber attack, the attacker can use the stolen session token to gather information about the network, identify valuable targets, and potentially steal sensitive data.

### 2. Solution Statement

It has now been found that the foregoing problems may be addressed by including an artifact signed with the user's non-custodial key in the session token. This enables transparent zero-knowledge token ownership validation on every transaction request containing a session token, and thus prevents lateral movement exploits in cyber or ransomware attacks by ensuring the authenticity of the user and the validity of the session. This may be accomplished, for example, through the steps of key generation, session token generation, and session token validation.

In the key generation step, a user generates a private/public key pair and keeps the private key in their own custody, while making the public key available to the service provider.

In the session token generation step, when the user logs in, the service provider generates a session token, which includes an artifact signed with the user's private key. This artifact can be a digital signature, a JWT, or some other format that is verified by the service provider using the user's public key.

In the session token validation step, the session token is sent to the user and is used to authenticate subsequent requests. When a request is received, the service provider verifies the artifact in the session token using the user's public key. If the signature is valid, the request is considered authenticated.

By requiring a signature from the user's private key, the session token is bound to the user's identity and can be used to track their activity throughout the session. If an attacker steals the session token, they will not be able to use it to perform lateral movement exploits, as the signature will be invalid and the session will be terminated.

Using an artifact signed with the user's non-custodial key in a session token can help prevent lateral movement exploits by ensuring the authenticity of the user and the validity of the session and can be a useful tool in mitigating the impact of cyber or ransomware attacks.

### V. Miscellaneous

The digital ecosystems disclosed herein may have various applications. These include, without limitation, applications in the fields of communication, e-commerce, content creation and storage, social networking, healthcare, and education. In communications, these digital ecosystems may be utilized to facilitate communication and collaboration by providing tools for individuals and teams to communicate and work together in real-time, regardless of their location. In e-commerce, these digital ecosystems may be utilized in the implementation of online marketplaces and e-commerce platforms. Regarding content creation and storage, these digital ecosystems may be utilized to provide a range of tools and services for creating, storing, and sharing digital content, such as documents, images, and videos. In social networking, these digital ecosystems may be utilized in the provision of platforms for use by individuals and communities in interacting, sharing content, and building relationships. In healthcare, these digital ecosystems may be utilized to improve patient outcomes and to streamline healthcare delivery as, for example, by facilitating the handling of electronic health records (EHRs) for the secure store and access of patient information, and in the implementation of telemedicine services to allow patients to connect with healthcare providers from the comfort of their own homes. In education, these digital ecosystems may be utilized to enhance educational experiences and make them more accessible to students as, for example, by facilitating the implementation of online learning platforms and virtual classrooms provide new opportunities for students to access education and collaborate with their peers.

Various elements may be utilized in the digital ecosystems disclosed herein. These include, without limitation, smartphones, personal computers (including laptops, tablets, and desktops), wearables, cloud storage systems, social media platforms, e-commerce websites, and other connected devices such as smart home systems. In such ecosystems, data may be generated and shared across different devices and services, creating a network of interrelated systems that work together to enhance the user's experience.

Various embodiments of the systems disclosed herein may utilize specialized processors. These may include, for example, Quantum Processing Units (QPUs), Graphics Processing Units (GPUs), Application-Specific Integrated Circuits (ASICs), Field-Programmable Gate Arrays (FPGAs), Neural Processing Units (NPUs), Signal Processing Units (SPUs), Cryptographic Accelerators, Network Processing Units (NPUs), Low-Power IoT Processors, Quantum Cryptography Processors, or Quantum Cryptography Processors.

For example, some embodiments of the systems disclosed herein may utilize QPUs for cryptographic algorithms that are quantum-resistant, thereby ensuring long-term security of blockchain transactions against quantum computing threats. Some embodiments of the systems disclosed herein may include GPUs which are optimized for parallel processing tasks, which can be essential for complex calculations in blockchain consensus algorithms or AI model training. Some embodiments of the systems disclosed herein may utilize ASICs. For example, some embodiments of such systems may include ASICs that are custom-designed for specific blockchain protocols or encryption methods, offering superior efficiency and performance for those tasks. Some embodiments of the systems disclosed herein may utilize FPGAs. For example, some embodiments of such systems may include FPGAs which serve as highly customizable hardware that can be programmed for specific cryptographic tasks or blockchain network functions, offering a balance between general-purpose processors and ASICs. Some embodiments of the systems disclosed herein may utilize NPUs which are specifically designed for accelerating artificial intelligence (AI) and machine learning (ML) computations. These processors may handle tasks such as pattern recognition, natural language processing, and AI-driven decision-making more efficiently than general-purpose CPUs, making them ideal for AI-enhanced blockchain applications or smart contract analysis.

Some embodiments of the systems disclosed herein may utilize SPUs which are optimized for processing digital signals, these processors can be crucial for applications that require real-time data analysis, such as interpreting biometric data or environmental sensors. In the context of mobile Web3 nodes, SPUs may enhance the system's ability to process inputs from various sources quickly and securely.

Some embodiments of the systems disclosed herein may utilize cryptographic accelerators, which are specialized processors designed to speed up cryptographic operations such as encryption, decryption, hashing, and digital signature verification. By offloading these tasks from the main CPU, cryptographic accelerators can significantly improve the performance and security of blockchain transactions and data protection mechanisms.

Some embodiments of the systems disclosed herein may utilize NPUs that are tailored for managing network communications. NPUs may be utilized, for example, to optimize data packet routing, handling, and security protocols. They are particularly useful in decentralized networks, improving the efficiency and reliability of peer-to-peer communications within the blockchain infrastructure.

Some embodiments of the systems disclosed herein may utilize low-power IoT processors. Designed for Internet of Things (IT) devices, these processors may be optimized for low power consumption and efficient processing of IoT-specific tasks, such as sensor data collection and edge computing. Integrating low-power IoT processors into mobile Web3 nodes may enable the deployment of blockchain technologies in energy-constrained environments.

Some embodiments of the systems disclosed herein may utilize quantum cryptography processors designed to perform quantum key distribution and other quantum-resistant cryptographic operations. They may provide future-proof security for blockchain systems against potential quantum computing threats.

Some embodiments of the systems disclosed herein may utilize custom blockchain processors which may be tailored specifically for executing blockchain consensus algorithms or smart contract execution. Such processors may optimize specific aspects of blockchain operation such as, for example, increasing transaction throughput or reducing consensus time, enhancing the overall performance of the private chain network.

Various embodiments of the systems disclosed herein may also utilize secure hardware modules. These may include, for example, Trusted Platform Modules (TPMs), Hardware Security Modules (HSMs), Secure Enclaves (e.g., Intel SGX, ARM TrustZone), Embedded Secure Elements (SEs), Smart Card Chips, Secure Microcontrollers, Physically Unclonable Functions (PUFs), Secure Key Storage Modules (SKSMs), Quantum Key Distribution (QKD) Modules, or Firmware Protection Modules.

For example, some embodiments of the systems disclosed herein may utilize TPMs for securely storing cryptographic keys, digital certificates, and other sensitive data, ensuring that blockchain transactions and private chain network communications are secure.

Some embodiments of the systems disclosed herein may utilize HSMs to provide robust security for cryptographic operations and key management, often used in enterprise settings for high-assurance tasks like digital signature creation and verification.

Some embodiments of the systems disclosed herein may utilize secure enclaves (such as, for example, Intel SGX or ARM TrustZone) to offer protected areas within the processor for executing sensitive computations in isolation from the rest of the system, thereby enhancing privacy and security for blockchain applications and AI data processing.

Various embodiments of the systems disclosed herein may also utilize custom-designed circuits. These may include, for example, crypto processors, blockchain optimization circuits, or biometric authentication circuits.

For example, some embodiments of the systems disclosed herein may utilize custom crypto processors which are tailored for accelerating specific cryptographic algorithms (such as, for example, SHA-256 for Bitcoin) or zero-knowledge proof computations, thereby improving transaction processing times and energy efficiency.

Some embodiments of the systems disclosed herein may utilize SEs, which are dedicated microprocessors designed to provide high levels of security for cryptographic data and operations. These microprocessors may be used, for example, for storing cryptographic keys securely, performing secure boot, and ensuring the integrity and confidentiality of the data. Secure Elements can be integrated into mobile devices, IoT devices, and smart cards, providing a tamper-resistant storage environment.

Some embodiments of the systems disclosed herein may utilize Smart Card Chips. These chips are used in smart cards (e.g., SIM cards, bank cards) and may be utilized in these systems to offer secure storage for sensitive information such as digital identities, cryptographic keys, and personal data. In blockchain applications, they may be utilized to authenticate user identity securely and facilitate secure transactions.

Some embodiments of the systems disclosed herein may utilize Secure Microcontrollers. Such microcontrollers may include built-in security features, such as hardware-based encryption, secure boot mechanisms, and access control. They may be used in various devices to ensure that data processing and communication are secure from external threats.

Some embodiments of the systems disclosed herein may utilize PUFs. PUFs represent a technology which may be utilized to create a unique cryptographic identifier for a hardware device, based on the inherent physical variations of its components. PUFs may serve as a secure foundation for device authentication and key generation in a blockchain network, ensuring that each node is uniquely and securely identified.

Some embodiments of the systems disclosed herein may utilize SKSMs. These modules are specifically designed for the secure generation, storage, and management of cryptographic keys. They may be utilized to protect keys against extraction and misuse, providing a secure foundation for digital signatures, encryption, and identity verification in blockchain applications.

Some embodiments of the systems disclosed herein may utilize QKD Modules. These modules may be utilized to facilitate secure communication channels by distributing cryptographic keys using the principles of quantum mechanics. Integrating QKD in blockchain systems may provide a level of security that is theoretically immune to computing attacks, including those from quantum computers.

Some embodiments of the systems disclosed herein may utilize Firmware Protection Modules. These modules may be designed to protect device firmware from tampering and unauthorized modifications. They may be utilized to ensure that device firmware is authenticated and has not been altered, which is crucial for maintaining the integrity of the hardware root of trust in blockchain devices.

Some embodiments of the systems disclosed herein may utilize blockchain optimization circuits which are designed to enhance the performance of specific consensus mechanisms, such as reducing the latency in Proof of Stake (PoS) or optimizing the energy consumption of Proof of Work (PoW) mining operations.

Some embodiments of the systems disclosed herein may utilize biometric authentication circuits, which are dedicated circuits for processing biometric data with enhanced security and privacy, thereby ensuring that biometric binding in mobile Web3 nodes is fast, accurate, and secure against tampering or unauthorized access.

Various embodiments of the systems disclosed herein may also utilize custom-designed circuits. These may include, for example, energy harvesting circuits, blockchain acceleration circuits, secure communication interface circuits, tamper-detection circuits, biometric signal processing circuits, distributed ledger synchronization circuits, quantum-resistant cryptography circuits, or IoT integration circuits.

For example, some embodiments of the systems disclosed herein may utilize energy harvesting circuits, which may be designed to capture and convert ambient energy (such as, for example, solar, thermal, or kinetic energy) into electrical power for the device. In blockchain mobile Web3 nodes, such circuits may provide a sustainable power source, extending device operation and reducing dependency on traditional charging methods.

Some embodiments of the systems disclosed herein may utilize blockchain acceleration circuits. Such circuits may be optimized for specific blockchain operations, such as hash computation for mining, signature verification, or smart contract execution. These circuits may significantly speed up these processes while reducing energy consumption compared to general-purpose processors.

Some embodiments of the systems disclosed herein may utilize secure communication interface circuits. These circuits may be designed to enhance the security of data transmission between devices in the blockchain network. These circuits may implement advanced encryption protocols, error correction, and anti-jamming techniques to ensure the integrity and confidentiality of transmitted data.

Some embodiments of the systems disclosed herein may utilize tamper-detection circuits. These circuits may be designed to detect physical or environmental tampering attempts, such as temperature changes, light exposure, or physical breaches. They may be adapted to automatically initiate protective actions, such as erasing sensitive data or locking the device, to protect the integrity of the blockchain node.

Some embodiments of the systems disclosed herein may utilize biometric signal processing circuits. These circuits may be designed to accurately and efficiently process biometric data for authentication, identification, and other security applications, and may include several advanced features tailored to enhance performance, security, and user experience. These circuits may be tailored for processing various biometric data (such as, for example, fingerprint, facial, or iris patterns) with high efficiency and accuracy. These circuits may perform rapid biometric matching and authentication, enhancing the security and user experience of blockchain systems. In various embodiments of the systems and methodologies disclosed herein, biometric signal processing circuits may include or be adapted to implement multi-modal biometric support, high-speed processing capabilities, advanced signal filtering and enhancement, machine learning integration (for example, the ability to incorporate machine learning algorithms for dynamic adaptation to variations in biometric data over time, improving recognition accuracy and reducing false positives or negatives), energy-efficient operation, tamper-resistant designs, secure data storage, anti-spoofing technologies (for example, the circuits may integrate features to detect and prevent spoofing attacks, such as the use of fake fingerprints or photos, enhancing the security of biometric systems against fraudulent attempts), adaptive thresholding (the circuits may be adapted to dynamically adjust authentication thresholds based on the application's security requirements or the environmental context, optimizing the balance between security and user convenience), and privacy protection mechanisms (for example, the circuits may implement features to protect user privacy, such as template protection schemes that allow for authentication without storing actual biometric data or ensuring that biometric processing is performed locally on the device).

Embodiments of biometric signal processing circuits in embodiments of the systems and methodologies disclosed herein may be adapted to dynamically adjust authentication thresholds based on the application's security requirements or the environmental context through several sophisticated mechanisms and features. These may include, for example, contextual awareness, security level configuration, adaptive learning algorithms, user behavior analysis, risk-based authentication, environmental sensors, feedback loops, or customizable policies. By integrating these features, biometric signal processing circuits in the systems and methodologies disclosed herein may provide flexible, secure, and user-friendly authentication mechanisms that adapt in real-time to varying security requirements and environmental contexts, ensuring an optimal balance between security and convenience.

Embodiments of biometric signal processing circuits in embodiments of the systems and methodologies disclosed herein may be equipped with contextual awareness. In particular, these circuits may incorporate sensors or input mechanisms to assess environmental context, such as location sensors to determine if the authentication attempt is happening in a trusted location (e.g., home or office) or somewhere less secure. Based on this context, the circuit may adjust the authentication threshold to be stricter in less secure environments.

Embodiments of biometric signal processing circuits in embodiments of the systems and methodologies disclosed herein may be programmed with multiple security levels, each of which may be associated with a different authentication threshold. Applications or systems using the circuit may dynamically select the appropriate security level based on current security needs, automatically adjusting the threshold.

Some embodiments of biometric signal processing circuits in embodiments of the systems and methodologies disclosed may be equipped with adaptive learning algorithms. By incorporating machine learning algorithms, the circuit may learn from past authentication attempts to adjust thresholds dynamically. For example, if it detects that false rejection rates are high due to minor variations in biometric data under certain conditions, it may lower the threshold slightly to reduce inconvenience without significantly compromising security.

Embodiments of biometric signal processing circuits in embodiments of the systems and methodologies disclosed herein may utilize user behavior analysis. For example, these circuits may analyze user behavior patterns over time and adjust thresholds based on perceived risk. For instance, if a user consistently accesses a service from the same device and location, the system may lower the threshold slightly, while access attempts from new devices or locations may trigger a higher threshold.

Embodiments of biometric signal processing circuits in embodiments of the systems and methodologies disclosed herein may be equipped with risk-based authentication features. For example, by integrating with broader security systems to receive risk assessments based on other factors (such as, for example, time of access, type of requested operation, or presence of security threats), the circuit may adjust authentication thresholds in real-time. High-risk scenarios would necessitate stricter authentication (higher threshold), while lower-risk scenarios could afford more leniency.

Some embodiments of biometric signal processing circuits in embodiments of the systems and methodologies disclosed herein may be equipped with environmental sensors. In such embodiments, the circuit may use data from environmental sensors (such as, for example, light or noise levels) to infer the context of the authentication attempt and adjust thresholds accordingly. For example, attempts made in unusually dark or noisy environments might be subjected to stricter thresholds due to increased risk of fraudulent attempts.

Some embodiments of biometric signal processing circuits in the systems and methodologies disclosed herein may utilize feedback loops. Such embodiments may implement a feedback mechanism where the system learns from the outcomes of authentication attempts, adjusting thresholds to optimize the balance between security and user experience. This may involve, for example, analyzing the rates of false acceptances and rejections to fine-tune the threshold settings over time.

Some embodiments of biometric signal processing circuits in the systems and methodologies disclosed herein may utilize customizable policies. In these embodiments, administrators or users (where appropriate) may have permission to set policies that dictate how thresholds should be adjusted based on specific criteria, such as time of day, transaction value (for financial applications), or the sensitivity of the data being accessed.

Some embodiments of the systems disclosed herein may utilize distributed ledger synchronization circuits. These circuits may be specifically designed to optimize the synchronization process of distributed ledgers in blockchain networks. These circuits may manage data propagation and consensus mechanisms more efficiently, reducing latency and improving the overall performance of the network. In various embodiments of the systems disclosed herein, distributed ledger synchronization circuits may include, implement or facilitate implementation of high-speed data processing, low-latency communication interfaces, energy-efficient designs, fault tolerance mechanisms, scalability features, security features, consensus algorithm optimization (for example, these circuits may be optimized for specific consensus algorithms (such as, for example, PoW, Proof of Stake, Delegated Proof of Stake, or the like), thereby enhancing the efficiency and speed of the consensus process), interoperability support, data compression techniques, or blockchain protocol accelerators (these may include, for example, specific components within the circuit dedicated to accelerating blockchain protocol operations, such as cryptographic hashing, signature verification, and smart contract execution).

Some embodiments of the systems disclosed herein may utilize quantum-resistant cryptography circuits. With the advent of quantum computing, these circuits may be designed to implement quantum-resistant cryptographic algorithms that can secure blockchain transactions against quantum attacks. Such circuits may be utilized to ensure long-term security of blockchain systems by providing advanced cryptographic capabilities. Various embodiments of quantum-resistant cryptography circuits may include, implement or facilitate the implementation of post-quantum algorithms (thus, for example, these circuits may be adapted to execute post-quantum cryptographic algorithms, such as lattice-based, hash-based, code-based, and multivariate polynomial public key schemes, which are believed to be resistant to quantum computer attacks), high-performance processing capabilities, scalable architectures, secure key management, energy efficiency, integrated quantum random number generators (QRNGs), hardware-based security features (including, for example, tamper-detection and response mechanisms to protect the circuit from physical attacks and ensure the integrity of the cryptographic operations), compatibility and interoperability features (that is, features designed to ensure compatibility with existing communication protocols and cryptographic standards, facilitating their integration into current infrastructure while providing a pathway to transition to quantum-resistant technologies, firmware update mechanism, or error correction capabilities.

Some embodiments of the systems disclosed herein may utilize IoT integration circuits. These circuits may be adapted to facilitate the integration of IoT devices into the blockchain network, managing data collection, processing, and secure transmission. They may be utilized to enable IoT devices to participate in blockchain ecosystems efficiently, expanding the application scope of the technology. Various embodiments of IoT integration circuits may include, implement or facilitate several key features or functionalities to address the unique challenges and requirements of IoT applications in a blockchain context. These may include, for example, low power operation, secure data transmission, edge computing capabilities, tamper resistance, multi-protocol support, scalability and flexibility, decentralized identification verification, smart contract interaction, quantum-resistant security, and interoperability features.

In some embodiments of the systems and methodologies disclosed herein, novel methods are utilized for secure communication between mobile Web3 nodes within a peer-to-peer (P2P) network. The foundation of this security protocol is the establishment of encrypted channels, underpinned by a Hardware Root of Trust. Each node or mobile device within the network integrates a secure cryptographic processor, serving both as the bedrock of trust and as the mechanism for generating and securely storing cryptographic keys. These keys are pivotal for the tamper-resistant encryption and decryption processes, ensuring that all data transmitted across the network remains confidential and intact, safeguarded by end-to-end encryption.

One possibly critical aspect of such a method is the utilization of biometrically bound credentials for robust user authentication. This process employs one or more biometric authentication methods, including but not limited to fingerprinting, facial recognition, and retinal scans, to bind digital credentials uniquely to a user's biometric data. Such biometrically bound credentials are securely stored and are essential for the user verification process, wherein captured biometric data at the time of authentication is compared with the stored credentials. Successful verification grants the user access to their mobile Web3 node, enabling secure communication.

Enhancing the security and efficiency of message delivery across the network, this method employs an AI-driven mechanism for routing messages. This AI mechanism is designed to dynamically select the most secure and efficient paths for message transmission between nodes, incorporating privacy-preserving techniques (such as, for example, onion routing) to anonymize message sources and destinations. This approach not only protects the integrity and confidentiality of the data but also optimizes network performance.

Further elaborating on the security measures, in some embodiments of systems of this type, the system periodically updates cryptographic keys to maintain the highest level of encryption security. These updates occur at predefined intervals or in response to detected security breaches, ensuring the network's resilience against evolving threats. Additionally, the secure cryptographic processor is tasked with executing secure boot processes, verifying the integrity of the mobile device's operating system at startup, thereby thwarting unauthorized access attempts or malicious exploits.

Some embodiments of the systems and methodologies disclosed herein also introduce a fail-safe mechanism, locking the mobile Web3 node against unauthorized use after a predetermined number of unsuccessful identity verification attempts. This feature, coupled with liveness detection in biometric authentication, significantly reduces the risk of spoofing attacks, providing a fortified layer of security.

To further ensure the non-repudiation and integrity of transactions over a network, some embodiments of the systems and methodologies disclosed herein leverage blockchain technology. Such integrations may not only facilitate a transparent and immutable record of transactions, but also allow for the use of private or consortium blockchains to restrict network participation to authorized nodes, thereby enhancing privacy and security.

In some embodiments of the foregoing systems and methodologies, the AI-driven routing mechanism is continuously refined using machine learning algorithms, which analyze historical communication patterns to improve routing decisions. This system is capable of detecting and mitigating potential security threats, including denial-of-service (DoS) attacks, by intelligently rerouting traffic away from affected nodes. A user interface on each mobile Web3 node provides real-time feedback on the network's security status, alerting users to any anomalies or threats detected.

Various embodiments are disclosed herein of systems designed to enhance decentralized data storage and communication across mobile Web3 nodes. The present disclosure details various methods and technologies utilized in these systems, including biometric binding, AI-driven interfaces for zero-ID transactions, and secure P2P network establishment. Some notable features across these various embodiments include advanced security protocols leveraging Hardware Root of Trust and encrypted storage, dynamic network management via smart contracts, and user-centric interfaces for interaction and transaction management. Embodiments of the systems disclosed herein integrate machine learning for adaptive user experience, blockchain technologies for secure transaction processing, and robust identity verification mechanisms. Various embodiments of the systems and methodologies disclosed herein build on the core principles of security, privacy, and user convenience, positioning the systems disclosed herein as comprehensive solutions for decentralized application deployment and management in the mobile Web3 ecosystem.

Some embodiments of systems are disclosed herein for decentralized data storage on a network of mobile Web3 nodes. These systems employ innovative approaches to ensure secure, efficient, and user-friendly interaction within a peer-to-peer (P2P) framework. Each mobile Web3 node in the network is distinguished by a unique biometric identifier, integrating advanced biometric binding techniques such as fingerprint recognition, facial recognition, and iris scanning. This not only enhances security but also personalizes the user experience.

Central to preferred embodiments of these system is the creation of an AI with a user interface that leverages input from users to generate privacy-preserved zero-ID transactions and establish a private chain network. This network facilitates secure P2P communication channels, supported by a robust Hardware Root of Trust and encrypted storage for private keys and transaction data.

The system's architecture includes mechanisms for secure booting, voice command support for transaction management, and NFC capabilities for contactless transactions. A blockchain network underpins the privacy-preserved zero-ID transactions, utilizing ring signatures and other anonymity features to protect user identities.

To maintain network integrity and adaptability, these systems preferably employ proof-of-stake (PoS) consensus mechanisms and are designed to automatically scale their infrastructure. Additional features may include a loyalty rewards mechanism to incentivize user participation, dispute resolution frameworks, and integrated digital wallets for managing cryptocurrencies and digital assets.

Various enhancements (such as, for example, automatic software updates, data analytics tools, and an integrated marketplace for digital goods and services) may be provided to further enrich the system's functionality. Preferred embodiments prioritize user privacy, security, and convenience, setting a new standard for decentralized data management and transactions in the mobile Web3 ecosystem.

Systems are disclosed herein for decentralized data storage across a network of mobile Web3 nodes. These systems may integrates cutting-edge technologies to secure and manage data efficiently, focusing on user-centric features for enhanced interaction and security within the peer-to-peer (P2P) framework.

The core of these systems is preferably built around mobile Web3 nodes, each equipped with a tangible, non-transient memory device containing software instructions. These instructions preferably enable the establishment of a Hardware Root of Trust, leveraging secure cryptographic processors and secure boot mechanisms to ensure system integrity from the ground up. Biometric binding, utilizing a range of biometric modalities, may be leveraged to provide a secure and unique method for user authentication, further enhanced by the use of encrypted storage for critical data such as private keys and transaction information.

In some embodiments, an AI with a user interface is central to this system and is designed to receive user inputs and facilitate privacy-preserved zero-ID transactions and the creation of a private chain network. This AI preferably leverages machine learning algorithms to adapt its functionality to user preferences, supporting advanced features such as, for example, voice commands, NFC capabilities for contactless transactions, and augmented reality (AR) for an immersive user experience.

In preferred embodiments, the private chain network, underpinned by a consensus mechanism such as Proof of Stake (PoS), ensures secure and efficient validation of transactions. It is preferably designed to scale automatically in response to network demand, incorporating smart contracts for dynamic network management and supporting a decentralized identity (DID) management system for the creation, storage, and management of digital verifiable credentials.

In preferred embodiments, robust security protocols are provided which employ end-to-end encryption, digital signatures, and multi-signature transactions to safeguard communications and transactions across the network. Preferred embodiments of the system also feature a dedicated policy enforcement point (PEP) for each resource, compliant with NIST 800-207 standards, to maintain decentralized policy management. By integrating these advanced features and technologies, the system provides a secure, scalable, and user-friendly platform for decentralized data storage and management, positioning it at the forefront of innovations in the mobile Web3 ecosystem.

Some embodiments of the systems and methodologies disclosed herein utilize the establishment of a Hardware Root of Trust, preferably by leveraging a secure cryptographic processor within each mobile Web3 node. This processor may be central to generating and securely storing cryptographic keys, serving as the cornerstone of a security framework. Biometric binding, utilizing a comprehensive range of modalities such as facial recognition, fingerprint scanning, and iris scanning, may be utilized to ensure that each node is uniquely associated with its user, enhancing the security and personalization of the network.

In some embodiments, an AI with a user interface is utilized, which marks a significant advancement in how users interact with the network. This AI is preferably designed to process user inputs, enabling privacy-preserved zero-ID transactions and the establishment of a private chain network. Through the use of suitable machine learning algorithms, the AI adapts to user preferences and behavior, optimizing the transaction process and enhancing the overall user experience.

Preferred embodiments of the systems and methodologies disclosed herein also encompasses the integration of a digital wallet for managing cryptocurrencies and digital assets, and the deployment of smart contracts to automate transaction processing within the private chain network. A decentralized application (dApp) marketplace is preferably provided for users to access a wide range of applications directly from their mobile Web3 node.

To ensure the integrity and authenticity of data shared over the network, some embodiments of the systems and methods disclosed herein may utilize digital signatures and end-to-end encryption protocols for establishing secure communication channels between nodes. Additionally, suitable decentralized network management protocols may be utilized to monitor and manage the performance and health of the network. These management protocols may adapt to emerging threats and technologies through automatic software and security protocol updates.

It will be appreciate that some embodiments of the systems and methodologies disclosed herein offer comprehensive solutions that not only secure communication within the P2P network but also foster a dynamic, user-centric ecosystem for decentralized application development and management, paving the way for innovative applications of blockchain technology in mobile environments.

Some embodiments of the systems and methodologies disclosed herein leverage unique biometric identifiers of users (such as, for example, fingerprints, facial recognition data, and iris scans) to ensure secure and personalized access to the network. These identifiers may be crucial for establishing trust and verifying the identity of each node within the network, enhancing the overall security of data transactions.

In some embodiments of the systems disclosed herein, a distributed ledger acts as the backbone of the system, enabling the real-time updating of data as it is added or modified across the network. This ledger preferably employs asymmetric cryptography for data encryption, thus ensuring that data chunks are securely encrypted and distributed among network nodes. The use of public and private keys in these embodiments allows for secure data sharing while maintaining the confidentiality of the data originator.

To maintain the integrity of the data stored within the network, the system may incorporate suitable consensus algorithms to validate transactions and data additions. Such algorithms, along with data redundancy checks performed by each network node, may be utilized to ensures that the data's integrity is preserved across the network, even if parts of the network become unavailable.

Preferred embodiments of the system also support smart contracts for automated data management tasks, thus facilitating efficient and automated interactions among network nodes. In such embodiments, a user interface on each mobile device may be provided and utilized to allow users to manage access to their stored data, sharing it selectively with other nodes or external entities based on biometric verification.

In some embodiments, an audit trail feature may be employed to track data access and modifications across the network, providing a transparent and secure method for monitoring data transactions. This comprehensive approach not only secures data within the decentralized network but also enhances the functionality and user experience of managing decentralized applications (dApps) on mobile Web3 nodes.

To underpin the secure communication method for mobile Web3 nodes in a P2P network, various embodiments of the systems and methodologies disclosed herein leverage several innovative aspects. In some embodiments, the foundation of these systems and methodologies is the establishment of encrypted channels within the network, anchored by a Hardware Root of Trust. This trust is instantiated by integrating a secure cryptographic processor within each mobile device, tasked with generating and securely storing cryptographic keys. These keys facilitate tamper-resistant encryption and decryption processes, ensuring end-to-end protection of all data transmitted across the network.

For user authentication, some embodiments of these systems and methodologies leverage biometrically bound credentials, utilizing a variety of biometric authentication processes (including, for example, fingerprinting, facial recognition, and retinal scans). This multi-modal approach not only enhances security by binding digital credentials to unique biometric data but also supports dynamic updating of biometric data to maintain identity accuracy and security.

In some embodiments, AI-driven mechanisms may be utilized to optimize message delivery across the P2P network. Such mechanisms may harness privacy-preserving techniques (such as, for example, onion routing) to anonymize message sources and destinations, ensuring the confidentiality of communications. The AI mechanism is preferably configured to dynamically select the most secure and efficient path for message delivery, thus adapting to network conditions in real time.

Embodiments of the methodologies disclosed herein may include provisions for the periodic updating of cryptographic keys, thereby enhancing security resilience. In the event of a detected security breach, keys may be promptly updated to mitigate potential vulnerabilities. Additionally, secure cryptographic processors may be provided which preferably support secure boot processes which verify the integrity of the mobile device's operating system at startup, and may also be provided with mechanisms to lock the mobile Web3 node against unauthorized use after failed identity verifications.

Some embodiments of the systems and methodologies disclosed herein may integrate blockchain technologies to ensure the non-repudiation and integrity of transactions across the P2P network. In embodiments including AI-driven routing mechanisms, these mechanisms may be further refined with machine learning algorithms to improve routing efficiency and privacy protection based on historical communication patterns. This comprehensive approach to secure communication in mobile Web3 nodes represents a significant advancement in the field of decentralized digital interactions, and may be leveraged to provide a robust framework for privacy, security, and user convenience.

In some embodiments, the innovative mobile Web3 node devices disclosed herein are at the forefront of enabling secure and efficient decentralized application (dApp) interaction within a peer-to-peer network. These devices are preferably equipped with a tangible, non-transient memory unit, and may specifically incorporate solid-state drive (SSD) storage for rapid access and durability. This memory device may be critical for housing the software instructions that, when executed, empower the device with its unique capabilities.

Preferred embodiments of the device feature a sophisticated biometric scanner capable of capturing a plurality of biometric modalities including, but not limited to, fingerprints and facial recognition. This multi-modal approach may be utilized to enhance the security and flexibility of user identification processes. In preferred embodiments, a secure processing unit may be utilized to reinforce the device's security framework. This secure processing unit preferably houses a cryptographic engine for the encryption and decryption of data, thereby ensuring the confidentiality and integrity of information processed by the device.

Preferred embodiments of the device include an integrated AI, which is preferably coupled with a user interface that supports voice commands. This AI is specifically designed to adapt and learn from user behavior patterns, thereby streamlining transaction processes and enhancing the overall user experience. The AI's capabilities are preferably directly accessible through a display screen that allows for touch inputs, thus facilitating intuitive and user-friendly navigation and operation within the private network and dApps.

Connectivity to the P2P network is preferably facilitated by a wireless communication module. This communications module may support protocols such as Wi-Fi and Bluetooth to ensure that the device remains versatile in various network environments. For financial transactions, a digital wallet may be seamlessly integrated into the user interface, thereby providing a secure and convenient means for managing cryptocurrency transactions and engaging with decentralized finance (DeFi) applications.

In preferred embodiments, the secure processing unit is foundational to the device's trustworthiness, and incorporates a Trusted Platform Module (TPM) for secure key storage and a physical unclonable function (PUF) for robust device authentication. The processing unit also preferably includes a secure enclave for the processing of sensitive data, thereby safeguarding user information against external threats.

In order to maintain optimal performance and security, the device is preferably equipped with a mechanism for automatic software updates via the P2P network. This ensures that the device's operating system (which is preferably optimized for Web3 applications and services) and any integrated third-party applications remain up-to-date and secure against emerging vulnerabilities. Additionally, the device may feature a temperature sensor and a power management system to monitor its operating environment and optimize battery life during network operations, respectively.

It will be appreciated from the foregoing that mobile Web3 node devices are disclosed herein which embody a comprehensive solution for secure, efficient, and user-friendly participation in the P2P network, leveraging cutting-edge technologies to facilitate zero-ID transactions, private network communications, and an enriched user experience with decentralized applications.

A decentralized application (dApp) deployment and management framework for mobile Web3 nodes is disclosed herein which is designed to simplify the development, deployment, and management of dApps within a peer-to-peer network. This comprehensive system preferably includes a versatile set of tools that cater to various aspects of dApp development. It allows developers to leverage a library of pre-built smart contracts to streamline the creation of common dApp functionalities, significantly reducing development time. For crafting user interfaces, a graphical user interface builder may be provided to enable the design of intuitive and engaging interfaces without the need for extensive coding, enhancing the user experience.

In some embodiments, to ensure that dApps perform optimally on a network, a performance monitoring tool is provided that equips developers with insights into the efficiency and scalability of their applications. In such embodiments, collaboration may be facilitated through tools that integrate with existing code repositories, promoting code sharing and collaborative development efforts. In some embodiments, the creation of user guides and technical documentation may be simplified with a documentation generator, thereby assisting developers in clearly communicating the functionalities and usage of their dApps.

In some embodiments, before deployment, a blockchain simulation tool may be utilized for thorough testing in a virtualized blockchain environment, thereby ensuring that dApps function as intended in real-world conditions. The user interface is preferably designed to be as interactive and user-friendly as possible. It may include features such as personalized dApp recommendations, which may be tailored based on users' previous interactions and preferences, thereby enhancing discovery and engagement. A search functionality may be provided to empower users to find dApps by keywords, categories, or developer names, thus making navigation within the ecosystem straightforward.

The security of dApps and their users will typically be a primary consideration in various embodiments of the systems and methodologies disclosed herein. In such embodiments, security protocols may be utilized which employ biometric binding and a Hardware Root of Trust for dApp authentication and authorization. These provisions may be leveraged to ensure a high level of security and privacy. This protocol may be fortified with features such as dynamic risk assessment, end-to-end encryption for all dApp communications, and real-time monitoring of authentication attempts to prevent unauthorized access. Session management mechanisms and the ability to manage and revoke dApp permissions may be utilized to give users control over their data and privacy, aligning with the highest security standards in the industry.

The blockchain-based identity verification systems disclosed herein for mobile Web3 nodes may be utilized to revolutionize the security and privacy of digital interactions. Central to preferred embodiments of these systems is a robust mechanism dedicated to the creation and management of digital identities, which preferably utilizes a spectrum of biometric data. This mechanism may be utilized to ensure the establishment of secure and unique digital identities for each user within the peer-to-peer network, and preferably leverages advanced biometric technologies such as fingerprint, facial recognition, and iris scans.

To maintain the relevance and accuracy of these digital identities, preferred embodiments of the systems disclosed herein incorporate a dynamic update feature, allowing for the periodic refreshment of biometric data. This ensures that the digital identities remain secure and accurate over time. In such embodiments, users may be afforded the flexibility to tailor their security measures through the addition or removal of biometric modalities, adapting their digital identity to their changing needs or preferences.

Preferred embodiments of such systems prioritize the security of biometric information through an encrypted biometric data storage solution. This encryption safeguards users' biometric data against unauthorized access, thus ensuring that sensitive information is securely stored within the system. Preferred embodiments incorporate a user consent module which requires explicit user consent before any biometric data is captured, stored, or utilized for identity verification purposes.

In such embodiments, the verification process itself may be underpinned by a protocol leveraging zero-knowledge proofs, thus allowing for the secure verification of identities without the need to reveal the underlying biometric information. This protocol preferably includes a dynamic challenge-response mechanism for each verification attempt, significantly enhancing security by ensuring that each authentication session is unique and cannot be replicated.

To further bolster the system's versatility and user autonomy, features may be included for the temporary delegation of identity verification capabilities, thus enabling users to securely grant limited access to their identity under specific conditions. These features, along with the protocol's interoperability across various blockchain platforms and its emphasis on user anonymity within the peer-to-peer network, underscores a commitment to privacy and security.

In some embodiments, an update mechanism may be provided within the protocol to ensure the periodic refreshment of zero-knowledge proofs, maintaining the integrity and security of the identity verification process over time. Such comprehensive systems not only provide a secure foundation for digital interactions within the Web3 space but also foster a user-centric approach to identity verification and management.

The above description of the present invention is illustrative and is not intended to be limiting. It will thus be appreciated that various additions, substitutions and modifications may be made to the above described embodiments without departing from the scope of the present invention. Accordingly, the scope of the present invention should be construed in reference to the appended claims. For convenience, some features of the claimed invention may be set forth separately in specific dependent or independent claims. However, it is to be understood that these features may be combined in various combinations and subcombinations without departing from the scope of the present disclosure. By way of example and not of limitation, the limitations of two or more dependent claims may be combined with each other without departing from the scope of the present disclosure.

1-154. (canceled)

155. A system for decentralized application (dApp) deployment and management for mobile Web3 nodes, comprising:
a set of tools for developing, deploying, and managing dApps within a P2P network;
a user interface for discovering and interacting with dApps; and
a security protocol for dApp authentication and authorization based on biometric binding and Hardware Root of Trust.

156. The system of claim 155, wherein the set of tools includes a library of pre-built smart contracts for common dApp functionalities, simplifying the development process.

157. The system of claim 155, wherein the set of tools includes a graphical user interface builder, enabling developers to design user interfaces without extensive coding.

158. The system of claim 155, wherein the set of tools includes a performance monitoring tool for analyzing the efficiency and scalability of dApps on the P2P network.

159. The system of claim 155, wherein the set of tools includes tools that provide integration with existing code repositories, thereby facilitating code sharing and collaboration among dApp developers.

160. The system of claim 155, wherein the set of tools includes a documentation generator which assists developers in creating user guides and technical documentation for their dApps.

161. The system of claim 155, wherein the set of tools includes a blockchain simulation tool that allows developers to test dApps in a virtualized blockchain environment before deployment.

162. The system of claim 155, wherein the user interface includes personalized dApp recommendations based on the previous interactions and preferences of a user within the network.

163. The system of claim 155, further comprising a search functionality within the user interface which allows users to find dApps based on keywords, categories, or developer names.

164. The system of claim 155, wherein the user interface includes a rating and review system that allows users to provide feedback on dApps they have used.

165. The system of claim 155, wherein the user interface includes an interactive tutorial for new users on navigating the dApp ecosystem and understanding Web3 concepts.

166. The system of claim 155, wherein the user interface includes a tracking feature for users to track their transaction history and interactions with dApps.

167. The system of claim 155, wherein the user interface further comprises a social sharing feature which enables users to share dApps or dApp achievements with a network.

168. The system of claim 155, wherein the user interface integrates a notification system to alert users about updates or events related to their installed or followed dApps.

169. The system of claim 155, wherein the security protocol includes a dynamic risk assessment mechanism to adjust authentication requirements based on the transaction's context and perceived security risk.

170. The system of claim 155, wherein the security protocol includes an encryption layer that employs end-to-end encryption for all dApp communications, ensuring data privacy and integrity.

171. The system of claim 155, wherein the security protocol includes a monitoring feature for real-time monitoring of authentication attempts, and wherein said monitoring feature flags and mitigates potential unauthorized access or brute force attacks.

172. The system of claim 155, wherein the security protocol includes a session management mechanism that automatically logs out users after a period of inactivity or upon detecting anomalies in user behavior.

173. The system of claim 155, wherein the security protocol further comprises a dApp management mechanism that allows users to manage and revoke dApp permissions, thereby enhancing user control over their data and privacy.

174. The system of claim 155, wherein the security protocol includes a data sharing feature that allows for the secure sharing of biometric data across devices owned by the same user, thereby facilitating seamless multi-device authentication.
